(19) United States
(12) Patent Application Publication
(10) Pub. No.: US 2026/0082404 A1
(43) Pub. Date: Mar. 19, 2026

(54) METHODS AND ARRANGEMENTS FOR RESOURCE ALLOCATION FOR SIDELINK POSITIONING

(71) Applicant: Intel Corporation, Santa Clara, CA (US)

(72) Inventors: Kilian ROTH, Munich (DE); Gang XIONG, Portland, OR (US); Debdeep CHATTERJEE, San Jose, CA (US); Jihyun LEE, Santa Clara, CA (US); Toufiqul ISLAM, Milpitas, CA (US)

(73) Assignee: Intel Corporation, Santa Clara, CA (US)

(21) Appl. No.: 18/880,628

(22) PCT Filed: Aug. 3, 2023
(86) PCT No.: PCT/US23/29375

§ 371 Date: Jan. 2, 2025

Related U.S. Application Data
(60) Provisional application No. 63/394,872, filed on Aug. 3, 2022.
(60) Provisional application No. 63/412,298, filed on Sep. 30, 2022.
(60) Provisional application No. 63/485,664, filed on Feb. 17, 2023.

(51) Int. Cl. H04W 72/40; H04L 5/00; H04W 72/25

(52) U.S. Cl. CPC H04W 72/40; H04L 5/0051; H04W 72/25

(57) ABSTRACT

Logic may perform resource selection from a resource pool to deter-mine a set of resources from the resource pool for transmission of a reference signal. Logic may autonomously allocate the set of resources for a transmission of the reference signal within a physical sidelink shared channel (PSSCH) or as a standalone transmission. Logic may generate a control information signal to signal the set of resources for the reference signal, the control information signal comprising a source identifier field, a destination identifier field, and one or more fields to indicate automatic gain control, guard symbols, or a combination thereof. And logic may encode the control information signal for transmission to a second UE via the interface.

### CROSS REFERENCE TO RELATED APPLICATIONS

This application claims priority under 35 USC § 119 from U.S. Provisional Application No. 63/394,872, entitled “MODE 2 RESOURCE ALLOCATION FOR SIDELINK POSITIONING”, filed on Aug. 3, 2022, the subject matter of which is incorporated herein by reference. This application also claims priority under 35 USC § 119 from U.S. Provisional Application No. 63/412,298, entitled “MODE 2 RESOURCE ALLOCATION FOR SIDELINK POSITIONING”, filed on Sep. 30, 2022, the subject matter of which is incorporated herein by reference. This application also claims priority under 35 USC § 119 from U.S. Provisional Application No. 63/485,664, entitled “MODE 2 RESOURCE ALLOCATION FOR SIDELINK POSITIONING”, filed on Feb. 17, 2023, the subject matter of which is incorporated herein by reference.

### TECHNICAL FIELD

Embodiments herein relate to wireless communications, and more particularly, solutions for mode-2 resource allocation (RA) for sidelink (SL) positioning.

### BACKGROUND

Mobile communication has evolved significantly from early voice systems to today's highly sophisticated integrated communication platform. The next generation wireless communication system, fifth generation technology for broadband cellular networks (5G), or new radio (NR) will provide access to information and sharing of data anywhere, anytime by various users and applications. NR is expected to be a unified network/system that target to meet vastly different and sometimes conflicting performance dimensions and services. Such diverse multi-dimensional requirements are driven by different services and applications. In general, NR will evolve based on 3GPP LTE-Advanced with additional potential new Radio Access Technologies (RATs) to enrich people lives with better, simple, and seamless wireless connectivity solutions. NR will enable everything connected by wireless and deliver fast, rich contents and services.

With wide bandwidth for positioning signal and beamforming capability in mmWave frequency band, higher positioning accuracy can be achieved by RAT dependent positioning techniques.

### BRIEF DESCRIPTION OF THE DRAWINGS

FIG. 1A illustrates an embodiment of a communication network;

FIG. 1B depicts an embodiment of one example of sidelink positioning with anchor UEs and target UE;

FIG. 1C depicts an embodiment of an example of the two modes for SL resource allocation for positioning;

FIG. 2 depicts an embodiment of a simplified block diagram of a base station and a user equipment (UE);

FIG. 3 depicts an embodiment of a graph showing positioning error due to movement between RTT transmissions communications;

FIG. 4A depicts an embodiment of a periodic SL resource allocation;

FIG. 4B shows communications between a roadside unit (RSU)) and a UE such as the UEs in FIGS. 1A-C, and 2;

FIGS. 4C-G shows different embodiments for SL resource allocation in a shared resource pool (s-pool) for aperiodic transmissions for RTT-based ranging/positioning;

FIG. 4H shows an embodiment for a message sequence for SL resource allocation in a shared resource pool (s-pool) for aperiodic transmissions for RTT-based ranging/positioning;

FIG. 4I shows an embodiment for multiplexing of PSCCH/PSSCH and SL PRS in a shared resource pool;

FIG. 5A shows an embodiment for examples of different frequency allocation options for SL PRS frequency resource for a dedicated resource pool;

FIG. 5B shows an embodiment of time allocation within a window W for a dedicated resource pool;

FIG. 5C shows an embodiment of multiplexing of PSCCH and SL PRS in a dedicated resource pool;

FIG. 5D shows an embodiment of one-to-one mapping between PSCCH subchannel and SL PRS resource in a dedicated resource pool;

FIG. 6 depicts a flowchart for a UE to allocate SL resources for sidelink communications such as the embodiments described in conjunction with FIGS. 1A-1C, 2-3, 4A-I, and 5A-5E;

FIG. 7 depicts a flowchart for sidelink (SL) positioning by a UE such as the embodiments described in conjunction with FIGS. 1A-1C, 2-3, 4A-4I, 5A-5D, and 6;

FIG. 8 depicts an embodiment of protocol entities in wireless communication devices such as the base station and user equipment shown in FIGS. 1A-1C and 2;

FIG. 9 depicts embodiments of the formats of physical layer data units (PDUs) that form via baseband circuitry and RF transceiver circuitry such as the baseband circuitry and the RF transceivers shown in FIG. 2;

FIGS. 10A-B depicts embodiments of communication circuitry such as the components and modules shown in the user equipment and base station shown in FIG. 2;

FIG. 11 depicts an embodiment of a storage medium described herein;

FIG. 12 depicts an embodiment of an architecture of a system of a network such as the communication networks in FIGS. 1A-1C;

FIG. 13 depicts an embodiment of a device such as a base station or user equipment shown in FIGS. 1A, 1B, 1C, and 2;

FIG. 14 depicts an embodiment of interfaces of baseband circuitry such as the baseband circuitry shown in FIG. 2; and

FIG. 15 depicts an embodiment of a block diagram of components to perform functionality described herein such as the functionality described in conjunction with FIGS. 1-14.

### DETAILED DESCRIPTION OF EMBODIMENTS

The following is a detailed description of embodiments depicted in the drawings. The detailed description covers all modifications, equivalents, and alternatives falling within the appended claims.

The automotive industry is currently transitioning towards automated driving and advanced driver assisted systems, where vehicles are able to react by themselves to changes in the driving environment. In this context, Vehicular-to-everything (V2X) is seen as a key technology to provide complete environmental awareness around the vehicle by exchanging messages with other vehicles, roadside units, and pedestrians with low latency and high reliability. V2X communications are expected to provide potentiality in different areas, like faster alerts and notifications, law enforcement, better service on roadways, reduced world-wide traffic load, reduced emissions, time savings, and increased automotive safety, thus contributing to prevent crashes/injuries and save lives.

The 3rd Generation Partnership Project (3GPP) is working towards its evolution in New Radio (NR) systems in the context of the so-called NR V2X. This new technology is expected to complement LTE C-V2X for advanced services by offering low latency, high reliability, and high throughput V2X services for advanced driving use cases. To do this, NR V2X is equipped with new features, such as the support for groupcast and unicast communication, a novel feedback channel, and a new control channel design.

NR V2X supports highly precise positioning in the vertical and horizontal dimensions, which relies on timing-based, angle-based, power-based or hybrid techniques to estimate the user location in the network. In particular, the following RAT dependent positioning techniques have been introduced, which can meet the positioning requirements for various use cases, e.g., indoor, outdoor, Industrial internet of thing (IoT), etc.: Downlink time difference of arrival (DL-TDOA), Uplink time difference of arrival (UL-TDOA), Downlink angle of departure (DL-AoD), Uplink angle of arrival (UL AoA), Multi-cell round trip time (multi-RTT), and NR enhanced cell ID (E-CID).

Embodiments herein may describe allocation of sidelink (SL) resources such as uplink (UL) resources, downlink (DL) resources, and flexible resources to schedule sounding or reference signals to determine and convey positioning information. Some embodiments may define resource allocation pools for allocation of resources, configuration of resource allocation pools, and use of pools for resource allocation. Some embodiments may define signaling to schedule reference signals, communicate decoding or demodulation information for resource allocation as well as positioning related information. Some embodiments define signaling to define how to respond to position information such as round-trip time (RTT) information for ranging determinations. Some embodiments may define priority information for scheduling reference signals in a resource pool. Some embodiments may define triggering for reference signals for SL positioning.

Two modes have been defined for centralized and distributed scheduling of UE transmissions, Mode 1 and Mode 2, which have been renamed as Scheme 1 and Scheme 2 in Rel 17, respectively. Centralized scheduling occurs at the eNB (in-coverage Scheme 1), whereas distributed scheduling is carried out by the device-to-device (D2D) or vehicle-to-vehicle (V2V) UEs themselves, with no need to be in the coverage area of an eNB (out-of-coverage Scheme 2). For Scheme 1, the NR base station (gNB) schedules sidelink resources to be used by the UE for sidelink transmissions. For Scheme 2, resource logic circuitry of the UE may autonomously determine sidelink transmission resources within sidelink resources configured by the gNB or pre-configured by the cellular network.

Scheme 2 is a distributed scheduling approach to sidelink (SL) resource allocation for positioning. For periodic traffic, in many embodiments, resource logic circuitry of a UE may perform resource selection via a sensing-based resource selection to select resources that are not in use by other UEs. For aperiodic traffic, in many embodiments, resource logic circuitry of a UE may implement short-term sensing and dynamic reservation.

Both schemes share the same resource allocation structure, in which the transmission of data is scheduled within a sidelink control period. Within the sidelink control period, a set of subframes are allocated for the Physical Sidelink Control Channel (PSCCH) transmission and a different set of subframes are allocated for the Physical Sidelink Shared Channel (PSSCH). The corresponding PSCCH for a given PSSCH is sent before the PSSCH data. The PSCCH comprises a first stage Sidelink Control Information (SCI), also referred to as a scheduling assignment, and the PSSCH may comprise a second stage SCI, from which a receiver may identify the occupation of the PSSCH radio resources. In both schemes, the SCI may be transmitted twice using different subframes in the same Resource Block (RB). The second transmission may improve the reliability of the SCI message delivery at the receiver due to the lack of a feedback channel in sidelink communication. The receiver blindly detects the SCI by monitoring all possible PSCCH resources. The transmitter UE may transmit a transport block four times in four consecutive subframes within the resource pool to allow the receiver UE to implement open loop Hybrid Automatic Repeat Request (HARQ) by combining the four redundancy versions of the transport block.

To support a wide range of V2X applications with different quality of service requirements and support scenarios with high vehicular density, 3GPP has continued standardization efforts on V2X communications through NR V2X in Release 16 and 17. NR V2X has been designed to support various use cases. In some embodiments, resource logic circuitry of the UEs and the cellular network (e.g., access nodes (ANs), or base stations) may support transmission of periodic traffic as well as reliable delivery of aperiodic messages for NR V2X Scheme 2 allocation for SL positioning.

NR V2X goes beyond the only broadcast communications proposed by LTE C-V2X and provides support for three types of transmissions: broadcast, groupcast, and unicast. In NR V2X unicast transmissions, the transmitting UE has a single receiver UE associated with a communication. In groupcast transmissions, the transmitting UE communicates with a sub-set (or group) of UEs in its vicinity. Furthermore, broadcast transmissions enable a UE to communicate with all UEs within transmission range.

In many embodiments, resource logic circuitry of UEs and ANs may perform sidelink communications in NR V2X on the following physical channels: 1) the Physical Sidelink Broadcast Channel (PSBCH) for sending broadcast information (such as synchronization of the sidelink), 2) the PSCCH for sending control information (1st-stage-SCI), 3) the PSSCH for sending control (2nd-stage-SCI), data and Channel State Information (CSI) in case of unicast, 4) and the Physical Sidelink Feedback Channel (PSFCH) for sending HARQ feedback in case of unicast and groupcast modes. PSSCH may support modulation schemes such as QPSK, 16-QAM, 64-QAM, and 256-QAM. PSCCH may support QPSK transmission.

NR V2X may use the reference signals such as 1) the Sidelink Primary/Secondary Synchronization Signal (S-PSS/S-SSS) for synchronization. S-PSS/S-SSS are transmitted together with the PSBCH in the synchronization signal/PSBCH block (SSB). The SSB uses the same numerology as the PSCCH/PSSCH on that carrier. 2) Demodulation Reference Signals (DMRS) to estimate the channel, perform data decoding, and, in some embodiments, as a sounding or reference signal for SL positioning. 3) Phase Tracking Reference Signal (PT-RS) to compensate for phase noise. 4) Channel State Information Reference Signal (CSI-RS) to estimate the channel, report channel quality information, similarly to NR, and, in some embodiments, as a sounding or reference signal for SL positioning.

In some embodiments, resource logic circuitry of the UEs and/or ANs may use a reference signal such as 5) the Sidelink positioning reference signal (SL PRS) as a sounding or reference signal for SL positioning. The SL PRS may be a layer 1 reference signal also referred to as L1 SL PRS and resource logic circuitry may transmit the SL PRS within the PSSCH or as a standalone transmission. For Scheme 1 SL PRS resource allocation, a transmitting UE can receive a SL PRS resource allocation signaling from gNB through a dynamic grant, a configured grant type 1, or a configured grant type 2.

In some embodiments, resource logic circuitry of a UE may be configured or preconfigured with one or more sidelink resource pools. A sidelink resource pool may comprise resources for allocation for transmission and reception of PSCCH/PSSCH and may be associated with either sidelink resource allocation Scheme 1 or Scheme 2. In some embodiments, for SL PRS transmission, either dedicated resource pool(s) or shared resource pool(s) or both may be preconfigured or configured in the SL bandwidth part (BWP) of a carrier. In many embodiments, resource logic circuitry of a UE may be preconfigured or configured with one or more dedicated SL resource pools and preconfigured or configured with one or more shared SL resource pools.

In the frequency domain, a sidelink resource pool may comprise a number of contiguous subchannels. The size of each subchannel may be fixed and may be composed of N contiguous RBs. Both the number of subchannels and the subchannel size may be higher layer pre-configured, by the radio resource control (RRC) layer. NR V2X supports N=10, 15, 20, 25, 50, 75, and 100 RBs for possible sub-channel sizes. In the time domain, the resources (i.e., slots) available for sidelink are determined by repeating sidelink bitmaps. The bitmap may be pre-configured and characterized by a certain size. The resource pool parameter from RRC, sl-TimeResource, may define the bitmap size and take values such as 10, 11, 12, . . . , 160. In the case of Time Division Duplex (TDD), the resources available for sidelink are given by the combination of the TDD pattern and the sidelink bitmap. In many embodiments, the NR sidelink specification is flexible and any valid NR TDD pattern may be used with any structure of a sidelink bitmap, which has a size specified by the 3GPP specifications. Within the slots available for sidelink, the specific Orthogonal Frequency Division Multiplexing (OFDM) symbols used for sidelink transmission/reception may be fixed and pre-configured. Two RRC parameters may pre-configure the symbol index of the first symbol and the set of consecutive symbols in a slot available for sidelink.

In many embodiments, resource logic circuitry of a base station and/or a UE may support a shared resource pool and/or a dedicated resource pool for transmission and reception of PSCCH/PSSCH for resource allocation in Scheme 2.

For out-of-coverage NR V2X UE using Scheme 2 operating in any of the V2X bands, in the frequency domain, a sidelink resource pool may comprise a number of contiguous subchannels. On the other hand, resource logic circuitry of an in-coverage NR V2X UE operating in either Scheme 1 or Scheme 2, may determine a time/frequency structure as per the next-Generation Node B (gNB) provided TDD pattern, sidelink bitmap, and subchannels.

In many embodiments, the resource logic circuitry of a UE and the cellular network may define SCI format, SCI Format 1-A for the scheduling of PSSCH and 2nd-stage-SCI on PSSCH. In some embodiments, the resource logic circuitry of a UE and the cellular network may define a new 1st stage format, SCI format 1-B for the scheduling of the SL PRS. In many embodiments, the resource logic circuitry of a UE and the cellular network may also define three or more formats for 2nd stage SCI such as SCI Format 2-A, SCI Format 2-B, and SCI Format 2-C. In some embodiments, the resource logic circuitry of a UE and the cellular network may also define a fourth format for 2nd stage SCI such as SCI Format 2-D.

SCI format 2-A may convey information for the decoding of PSSCH, with HARQ operation when HARQ-ACK information includes ACK or NACK, when HARQ-ACK information includes only NACK, or when there is no feedback of HARQ-ACK information. In some embodiments, SCI format 2-B may convey information for the decoding of PSSCH, with HARQ operation when HARQ-ACK information includes only NACK, or when there is no feedback of HARQ-ACK information. SCI format 2-C may convey information for the decoding of PSSCH and providing inter-UE coordination information or requesting inter-UE coordination information. SCI format 2-C may be for unicast communications. In some embodiments, a new SCI Format 2-D may convey the decoding of PSSCH and the scheduling of SL PRS. In some embodiments, the SCI Format 2-D may comprise one or more of or all the following fields: HARQ process number—4 bits, New data indicator—1 bit, Redundancy version—2 bits, Source ID—8 bits, and Destination ID—16 bits, HARQ feedback enabled/disabled indicator—1 bit.

The fields defined in each of the 2nd-stage SCI formats below are mapped to the information bits a₀ to a_{A-1}. Each field is mapped in the order in which it appears in the description, with the first field mapped to the lowest order information bit do and each successive field mapped to higher order information bits. The most significant bit of each field may be mapped to the lowest order information bit for that field, e.g., the most significant bit of the first field is mapped to do.

The 1st-stage-SCI indicates the reservation of Nmax _reserve (preconfigured) number of sidelink resources within the resource selection window. Nmax _reserve may be 2 or 3. The resource reservation is indicated in the time resource assignment field of the 1st-stage-SCI. This means that not all the slots in a resource reservation period of a UE carry 1st-stage SCI in the PSCCH; some slots have empty PSCCH and only carry information in the PSSCH, as indicated by a 1st-stage-SCI in a previous slot.

In order to address Scheme 2 resource allocation (RA) for sidelink (SL) positioning, use cases such as autonomous driving, sidelink or vehicle-to-everything (V2X) based positioning are considered. More specifically, various scenarios including in-coverage, partial coverage, out of network coverage may be considered for sidelink positioning.

Some embodiments may implement sensing-based semi-persistent scheduling (SPS) for periodic traffic. This is defined as a distributed scheduling protocol to autonomously select radio resources. Sensing-based SPS UEs may reserve subchannels in the frequency domain for a random number of consecutive periodic transmissions in time domain. The number of slots for transmission and retransmissions within each periodic resource reservation period depends on the number of blind retransmissions (if any) and the resource selection procedure. The number of reserved subchannels per slot depends on the size of data to be transmitted. The sensing-based resource selection procedure is composed of two stages: 1) a sensing procedure and 2) a resource selection procedure.

Some embodiments may define mode-2 resource allocation (RA) for sidelink (SL) positioning for both cases of a shared resource pool (s-pool) with SL communication and a dedicated SL positioning resource pool (d-pool). Note that for s-pool, backwards compatibility may need to be ensured. The shared resource pool refers to resources that are shared with other SL communications described in releases 16 and 17 of 3GPP for NR systems. The dedicated resource pool may refer to resources that are dedicated for SL communications for vehicle to everything (V2X) and not shared with other communications. The resources generally describe the physical sidelink shared channel (PSSCH) radio resources (such as resource blocks and resource elements of subframes of frames) for communication of positioning information. The sidelink control information (SCI) is information communicated to reserve resources for communication of reference signals and positioning information in the PSSCH and is transmitted via the physical sidelink control channel (PSCCH).

For SL communication and positioning to coexist in the same resource pool (shared resource pool), the resource determination as well as resource reservation signaling in the first stage PSCCH may be the same for SL PRS transmissions.

In some embodiments, with regards to the SCI signaling in a shared resource pool, in addition to SL PRS transmission, the resource logic circuitry of the UE transmits SCI format 1-A (SCI 1-A) and a 2nd stage SCI format (such as SCI 2-D) for SL PRS indication.

For RANs, the base station may execute code and protocols for E-UTRA, an air interface for base stations and interaction with other devices in the E-UTRAN such as UE. The E-UTRA may include the radio resource management (RRM) in a radio resource control (RRC) layer.

Various embodiments may be designed to address different technical problems associated with scheme 2 resource allocation for SL positioning such as a current lack of support for highly precise positioning in scheme 2; a lack of support for resource allocations of positioning in the vertical and horizontal dimensions in scheme 2; a lack of support for timing-based, angle-based, power-based or hybrid techniques to estimate the user location in the network in scheme 2; a lack of support for SL resource allocation in scheme 2 for downlink time difference of arrival (DL-TDOA); a lack of support for SL resource allocation in scheme 2 for uplink time difference of arrival (UL-TDOA); a lack of support for SL resource allocation in scheme 2 for downlink angle of departure (DL-AoD); a lack of support for SL resource allocation in scheme 2 for uplink angle of arrival (UL AoA); a lack of support for SL resource allocation in scheme 2 for multi-cell round trip time (multi-RTT); a lack of support for SL resource allocation in scheme 2 for out of network coverage, and/or the like.

Different technical problems such as those discussed above may be addressed by one or more different embodiments. Embodiments may address one or more of these problems associated with scheme 2 resource allocation for SL positioning. For instance, some embodiments that address problems scheme 2 resource allocation for SL positioning may do so by one or more different technical means, such as, performing resource selection from at least one resource pool to determine a set of resources from the at least one resource pool for transmission of a reference signal in a physical sidelink shared channel (PSSCH); autonomously allocating the set of resources for a transmission of the reference signal within the PSSCH; generating a control information signal to signal the set of resources for the reference signal, wherein the control information signal comprises a source identifier field, a destination identifier field, and one or more fields to indicate automatic gain control, guard symbols, or a combination thereof; encoding the control information signal for transmission to a second UE; generating the reference signal for a unicast, broadcast, or groupcast transmission; encoding the reference signal for transmission via the set of resources within the PSSCH; selecting of periodic or aperiodic resources for the SL PRS; determining a resource selection window (RSW) to limit reservation of resources to a window of time for round trip time (RTT) based ranging; and/or the like.

Several embodiments comprise systems with multiple processor cores such as central servers, access points, and/or stations (STAs) such as modems, routers, switches, servers, workstations, netbooks, mobile devices (Laptop, Smart Phone, Tablet, and the like), sensors, meters, controls, instruments, monitors, home or office appliances, Internet of Things (IoT) gear (watches, glasses, headphones, cameras, and the like), and the like. Some embodiments may provide, e.g., indoor and/or outdoor “smart” grid and sensor services. In various embodiments, these devices relate to specific applications such as healthcare, home, commercial office and retail, security, and industrial automation and monitoring applications, as well as vehicle applications (automobiles, self-driving vehicles, airplanes, drones, and the like), and the like.

The techniques disclosed herein may involve transmission of data over one or more wireless connections using one or more wireless mobile broadband technologies. For example, various embodiments may involve transmissions over one or more wireless connections according to one or more 3rd Generation Partnership Project (3GPP), 3GPP Long Term Evolution (LTE), 3GPP LTE-Advanced (LTE-A), 4G LTE, and/or 5G New Radio (NR), technologies and/or standards, including their revisions, progeny and variants. Various embodiments may additionally or alternatively involve transmissions according to one or more Global System for Mobile Communications (GSM)/Enhanced Data Rates for GSM Evolution (EDGE), Universal Mobile Telecommunications System (UMTS)/High Speed Packet Access (HSPA), and/or GSM with General Packet Radio Service (GPRS) system (GSM/GPRS) technologies and/or standards, including their revisions, progeny and variants.

Examples of wireless mobile broadband technologies and/or standards may also include, without limitation, any of the Institute of Electrical and Electronics Engineers (IEEE) 802.16 wireless broadband standards such as IEEE 802.16m and/or 802.16p, International Mobile Telecommunications Advanced (IMT-ADV), Worldwide Interoperability for Microwave Access (WiMAX) and/or WiMAX II, Code Division Multiple Access (CDMA) 2000 (e.g., CDMA2000 1×RTT, CDMA2000 EV-DO, CDMA EV-DV, and so forth), High Performance Radio Metropolitan Area Network (HIPERMAN), Wireless Broadband (WiBro), High Speed Downlink Packet Access (HSDPA), High Speed Orthogonal Frequency-Division Multiplexing (OFDM) Packet Access (HSOPA), High-Speed Uplink Packet Access (HSUPA) technologies and/or standards, including their revisions, progeny and variants.

Some embodiments may additionally perform wireless communications according to other wireless communications technologies and/or standards. Examples of other wireless communications technologies and/or standards that may be used in various embodiments may include, without limitation, other IEEE wireless communication standards such as the IEEE 802.11-2020, IEEE 802.11ax-2021, IEEE 802.11ay-2021, IEEE 802.11ba-2021, and/or other specifications and standards, such as specifications developed by the Wi-Fi Alliance (WFA) Neighbor Awareness Networking (NAN) Task Group, machine-type communications (MTC) standards such as those embodied in 3GPP Technical Report (TR) 23.887, 3GPP Technical Specification (TS) 22.368, 3GPP TS 23.682, 3GPP TS 36.133, 3GPP TS 36.306, 3GPP TS 36.321, 3GPP TS.331, 3GPP TS 38.133, 3GPP TS 38.306, 3GPP TS 38.321, 38.214, and/or 3GPP TS 38.331, and/or near-field communication (NFC) standards such as standards developed by the NFC Forum, including any revisions, progeny, and/or variants of any of the above. The embodiments are not limited to these examples.

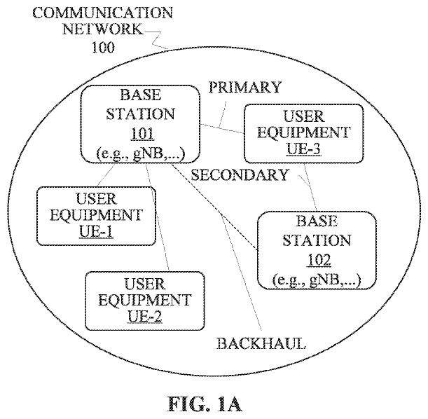

FIG. 1A illustrates an embodiment of a communication network 100. The communication network 100 is an Orthogonal Frequency Division Multiplex (OFDM) network comprising a primary base station 101, a first user equipment UE-1, a second user equipment UE-2, a third user equipment UE-3, and a secondary base station 102. In a 3GPP system based on an Orthogonal Frequency Division Multiple Access (OFDMA) downlink, the radio resource is partitioned into subframes in time domain and each subframe comprises of two slots. Each OFDMA symbol further consists of a count of OFDMA subcarriers in frequency domain depending on the system (or carrier) bandwidth. The basic unit of the resource grid is called Resource Element (RE), which spans an OFDMA subcarrier over one OFDMA symbol. Resource blocks (RBs) comprise a group of REs, where each RB may comprise, e.g., 12 consecutive subcarriers in one slot.

Several physical downlink channels and reference signals use a set of resource elements carrying information originating from higher layers of code. For downlink channels, the Physical Downlink Shared Channel (PDSCH) is the main data-bearing downlink channel, while the Physical Downlink Control Channel (PDCCH) may carry downlink control information (DCI). The control information may include scheduling decision, information related to reference signal information, rules forming the corresponding transport block (TB) to be carried by PDSCH, and power control command. UEs may use cell-specific reference signals (CRS) for the demodulation of control/data channels in non-precoded or codebook-based precoded transmission modes, radio link monitoring, and measurements of channel state information (CSI) feedback. UEs may use UE-specific reference signals (DM-RS) for the demodulation of control/data channels in non-codebook-based precoded transmission modes.

The communication network 100 may comprise a cell such as a micro-cell or a macro-cell and the base station 101 may provide wireless service to UEs within the cell. The base station 102 may provide wireless service to UEs within another cell located adjacent to or overlapping the cell. In other embodiments, the communication network 100 may comprise a macro-cell and the base station 102 may operate a smaller cell within the macro-cell such as a micro-cell or a picocell. Other examples of a small cell may include, without limitation, a micro-cell, a femto-cell, or another type of smaller-sized cell.

In various embodiments, the base station 101 and the base station 102 may communicate over a backhaul. In some embodiments, the backhaul may comprise a wired backhaul. In various other embodiments, backhaul may comprise a wireless backhaul. In some embodiments, the backhaul may comprise an Xn interface or a F1 interface, which are interfaces defined between two RAN nodes or base stations such as the backhaul between the base station 101 and the base station 102. The Xn interface is an interface for gNBs and the F1 interface is an interface for gNB-Distributed units (DUs) if the architecture of the communication network 100 is a central unit/distributed unit (CU/DU) architecture.

The base stations 101 and 102 may communicate protocol data units (PDUs) via the backhaul. As an example, for the Xn interface, the base station 101 may transmit or share a control plane PDUs via an Xn-C interface and may transmit or share data PDUs via a Xn-U interface. For the F1 interface, the base station 101 may transmit or share a control plane PDUs via an F1-C interface and may transmit or share data PDUs via a F1-U interface. Note that discussions herein about signaling, sharing, receiving, or transmitting via a Xn interface may refer to signaling, sharing, receiving, or transmitting via the Xn-C interface, Xn-U interface, or a combination thereof. Similarly, discussions herein about signaling, sharing, receiving, or transmitting via a F1 interface may refer to signaling, sharing, receiving, or transmitting via the F1-C interface, F1-U interface, or a combination thereof.

In some embodiments, the base stations 101 and 102 may comprise resource logic circuitry to establish or define one or more shared resource pools for sidelink control information (SCI) and/or one or more dedicated resource pools for SCI. In some embodiments, UEs such as UE-1 may be preconfigured for the cellular network to define one or more shared resource pools for sidelink control information (SCI) and/or one or more dedicated resource pools for SCI. Furthermore, the UE may perform sensing-based selection and/or random selection of SL resources for positioning in the one or more shared resource pools for sidelink control information (SCI) and/or one or more dedicated resource pools for SCI. In some embodiments, resource logic circuitry of the base station or the UE may be configured or preconfigured to exclusively use sensing-based resource allocation in one or more of the dedicated and/or shared resource pools.

In many embodiments, the resource logic circuitry of the UEs may use resources in the one or more shared resource pools for sidelink control information (SCI) and/or one or more dedicated resource pools for SCI based on partial sensing and/or full sensing to establish periodic and/or aperiodic SL resource allocations.

FIG. 1B depicts an embodiment 130 of one example of sidelink positioning with anchor UEs and target UE. In this embodiment, a “Target UE” corresponds to a UE to be positioned while an “Anchor UE” corresponds to a UE supporting positioning of target UE, e.g., by transmitting and/or receiving SL PRS and providing positioning-related information. Note that SL PRS may be transmitted between anchor and target UEs for sidelink positioning.

To illustrate, the UE-1 of FIG. 1A may comprise an anchor UE, which may support positioning of target UE such as UE-2 of FIG. 1A. The UE-1 may perform sensing of SL resources to select SL resources for periodic or aperiodic SL positioning for the UE-2. In some embodiments, the UE-1 may schedule SL resources for a SL PRS via transmission of a SCI format 1-B to the UE-2 in a unicast mode within a PSCCH. In such embodiments, the UE-2 may schedule SL resources for a response with positioning information. In some embodiments, the UE-1 may schedule SL resources for a SL PRS and SL resources for a response with positioning information via transmission of a SCI format 1-B to the UE-2 in a unicast mode within a PSCCH. The UE-1 may thereafter transmit the periodic or aperiodic SL PRS within a PSSCH or as a standalone transmission to the one or more target UEs and may receive, in response, positioning information from the UE-2 during the scheduled SL resources for the response. In other embodiments, the UE-1 may schedule a SL PRS via transmission of a SCI format 1-B to the UE-2 and one or more other target UEs in a groupcast mode or a broadcast mode. In still other embodiments, the UE-1 may schedule transmission of a different sounding reference signal, in lieu of the SL PRS, such as a demodulation reference signal (DMRS) or a Channel state information (CSI) reference signal (CSI-RS).

In some embodiments, the resource logic circuitry of one or more of the coordinating UEs such UEs may communicate with each other to prevent resource assignment conflicts and collisions between downlink (DL) SL PRS transmissions from different UEs within a set of transmitting UEs such as the anchor UEs. In some embodiments, the set of transmitting UEs is either same as or has no overlap or has partial overlap with the set of coordinating UEs. In some embodiments, the alignment between the coordinating UEs may be achieved via message exchanges using one or more of the following interfaces:
PC5 broadcast of the resource assignment for the participating devices assuming other coordination UEs also receive these messages.
PC5 resource pool user plane used for general communication.
PC5 resource pool user plane dedicated for such coordination.
PC5 control plane.
Using the data plane of the network.
Using the control plane of the network.
Any other communication interface between these coordinating UEs.

FIG. 1C depicts an embodiment 150 of an example of the two modes for SL resource allocation for positioning, mode 1 and mode 2, which are also referred to as scheme 1 and scheme 2, respectively. This example depicts an access node (gNB) that performs controlled resource allocation in mode 1 (scheme 1), scheduling SL resources for sidelink positioning with an anchor UE and a target UE. Mode 2 (scheme 2) is also illustrated where the UE autonomously select SL resources for allocation. Note that for scheme 2, the anchor UE may use sensor-based selection of the SL resources for scheduling the SL PRS and the positioning information. In some embodiments, the anchor UE may perform sensor-based resource selection based on full sensing. In other embodiments, the anchor UE may perform sensor-based resource selection based on partial sensing. In still other embodiments, the UE may use random-based selection of the SL resources for scheduling the SL PRS and the positioning information.

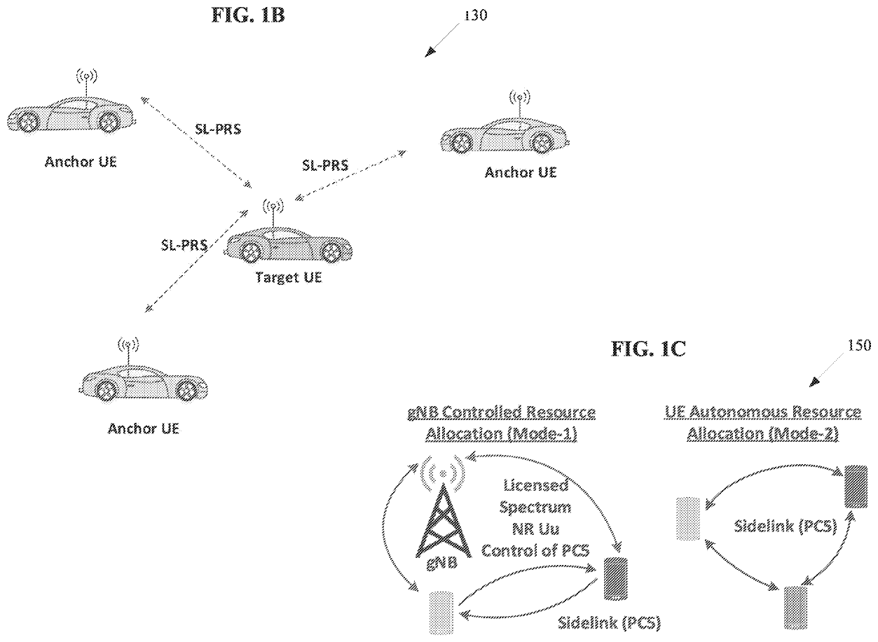

FIG. 2 depicts an embodiment of a simplified block diagram 200 of a base station 201 and a user equipment (UE) 211 that may carry out certain embodiments of the present invention in a communication network such as the base station 101, the UEs, and communication network 100 shown in FIGS. 1A, 1B, and 1C. For the base station 201, the antenna 221 transmits and receives radio signals. The RF circuitry 208 coupled with the antenna 221, which is the physical layer of the base station 201, receives RF signals from the antenna 231, converts the signals to digital baseband signals, or uplink data, and sends them to the processor 203 of the baseband circuitry 251, also referred to as the processing circuitry or baseband processing circuitry, via an interface of the baseband circuitry 251. The RF circuitry 208 also converts received, digital baseband signals, or downlink data, from the processor 203 via an interface of the baseband circuitry 251, converts them to RF signals, and sends the RF signals out to antenna 221.

The processor 203 decodes and processes the digital baseband signals, or uplink data, and invokes different functional modules to perform features in the base station 201. The memory 202 stores program instructions or code and data 209 to control the operations of the base station 201. The processor 203 may also execute code such as RRC layer code from the code and data 209 to implement RRC layer functionality.

A similar configuration exists in UE 211 where the antenna 231 transmits and receives RF signals. The RF circuitry 218, coupled with the antenna, receives RF signals from the antenna 221, converts them to baseband signals, or downlink data, and sends them to processor 213 of the baseband circuitry 261 via an interface of the baseband circuitry 261. The RF circuitry 218 also converts digital baseband signals, or uplink data, from the processor 213, converts them to RF signals, and sends out the RF signals to the antenna 231.

The RF circuitry 218 illustrates multiple RF chains. While the RF circuitry 218 illustrates five RF chains, each UE may have a different number of RF chains and each of the RF chains in the illustration may represent multiple, time domain, receive (RX) chains and transmit (TX) chains. The RX chains and TX chains include circuitry that may operate on or modify the time domain signals transmitted through the time domain chains such as circuitry to insert guard intervals in the TX chains and circuitry to remove guard intervals in the RX chains. For instance, the RF circuitry 218 may include transmitter circuitry and receiver circuitry, which is often called transceiver circuitry. The transmitter circuitry may prepare digital data from the processor 213 for transmission through the antenna 231. In preparation for transmission, the transmitter may encode the data, and modulate the encoded data, and form the modulated, encoded data into Orthogonal Frequency Division Multiplex (OFDM) and/or Orthogonal Frequency Division Multiple Access (OFDMA) symbols. Thereafter, the transmitter may convert the symbols from the frequency domain into the time domain for input into the TX chains. The TX chains may include a chain per subcarrier of the bandwidth of the RF chain and may operate on the time domain signals in the TX chains to prepare them for transmission on the component subcarrier of the RF chain. For wide bandwidth communications, more than one of the RF chains may process the symbols representing the data from the baseband processor(s) simultaneously.

The processor 213 decodes and processes the digital baseband signals, or downlink data, and invokes different functional modules to perform features in the UE 211. The memory 212 stores program instructions or code and data 219 to control the operations of the UE 211. The processor 213 may also execute medium access control (MAC) layer code of the code and data 219 for the UE 211. For instance, the MAC layer code may execute on the processor 213 to cause UL communications to transmit to the base station 201 via one or more of the RF chains of the physical layer (PHY). The PHY is the RF circuitry 218 and associated logic such as some or all the functional modules.

The base station 201 and the UE 211 may include several functional modules and circuits to carry out some embodiments. The different functional modules may include circuits or circuitry that code, hardware, or any combination thereof, can configure and implement. Each functional module may implement functionality as code and processing circuitry or as circuitry configured to perform functionality and may also be referred to as a functional block. For example, the processor 203 (e.g., via executing program code 209) is a functional block to configure and implement the circuitry of the functional modules to allow the base station 201 to schedule (via scheduler 204), encode or decode (via codec 205), modulate or demodulate (via modulator 206), and transmit data to or receive data from the UE 211 via the RF circuitry 208 and the antenna 221.

The processor 213 (e.g., via executing program code in the code and data 219) may be a functional block to configure and implement the circuitry of the functional modules to allow the UE 211 to receive or transmit, de-modulate or modulate (via de-modulator 216), and decode or encode (via codec 215) data accordingly via the RF circuitry 218 and the antenna 231.

Both the UE 211 and the base station 201 may include a functional module, resource logic circuitry 240 and 235 respectively. The resource logic circuitry 235 of the base station 201 may, in some embodiments, include some code and data 209 in the memory 202 and may cause the processor 203 to perform actions to configure one or more shared resource pools and/or one or more dedicated resource pools for scheme 2 SL resource allocation for UEs such as the UE 211. For instance, the processor 203 may cause the base station 201 to transmit a resource pool configuration to the UE 211 including configurations for the one or more shared resource pools and/or the one or more dedicated resource pools.

After transmitting the resource pool configuration to the UE 211, the resource logic circuitry 240 of the UE 211 may cause the processor 213 to perform autonomous SL resource allocations based on the configuration of the one or more shared resource pools and/or one or more dedicated resource pools for scheme 2 SL resource allocation. For example, the UE 211 may perform autonomous scheme 2 SL resource allocations from the one or more shared resource pools. For SL communication and positioning, to coexist in the same resource pool, the resource determination as well as resource reservation signaling in the first stage physical sidelink control channel (PSCCH) may be the same for SL PRS transmissions. In one embodiment, the 1st Stage SCI for SL PRS transmission in the shared resource pool is used in the same way as for transmissions of SL communication channels/signals and one of the resource indication bits may be used to indicate transmission of SL PRS along with transmission of PSCCH/PSSCH. In another variant of the embodiment, it may be indicated that DMRS associated with PSSCH may be used for positioning-based measurements. In some embodiments, the 1st Stage SCI may be used as a single stage SCI for SL PRS transmission.

In another embodiment, the resource logic circuitry of the UE 211 may communicate a new 2nd stage SCI format such as SCI format 2D comprising either only positioning related information or comprising positioning related information along with information necessary for the demodulation of the PSCCH and/or PSSCH. The positioning related information may comprise one or more of the following information fields:
a SL PRS presence field to indicate the presence of a SL PRS.
a SL PRS identification field that may include one or more of: a starting symbol for SL PRS, a number of symbols for SL PRS, a comb index for SL PRS, a starting physical resource block (PRB) for SL PRS, a number of PRBs or number of subchannels for SL PRS, a SL PRS resource index, a SL PRS resource set index, a SL PRS repetition index, and/or a number of repetitions for SL PRS transmission.
a PSCCH DMRS field that may indicate the presence of a DMRS with PSCCH resources of the shared resource pool, if used for positioning.
a PSSCH DMRS field that may indicate the presence of a DMRS with PSSCH resources of the shared resource pool, if used for positioning.
an Indication of DMRS symbol field to identify a symbol to be used for receiver (Rx) timing estimation.
an Information field to identify which DMRS layer may be used for positioning.
a CSI-RS field to indicate a presence of a CSI-RS, if used for positioning.
a Transmission time information field to indicate a time of transmission.
a Preceding reception time information field to indicate a time of a preceding reception.
a Round trip time (RTT) Information field to indicate how to respond to the position information for RTT based ranging.
a Source ID field to indicate a source ID of the transmitter of the SCI format 2D.
a Destination ID field to indicate a destination ID for an intended recipient of the SCI format 2D.
a Resource reservation period field to indicate a resource reservation period for a SL PRS.
a SL PRS priority field to indicate a priority for the SL PRS reservation.
a Cast type field to indicate a cast type, which may comprise an indication from higher layers such as the RRC layer.
One or more Indication fields to indicate presence of automatic gain control (AGC) and/or guard symbol between SL PRS resources within the SL PRS resource pool.

In another embodiment, the resource logic circuitry of the UE 211 may communicate the positioning related information via medium access control (MAC) control element (CE) (MAC CE) based signaling (layer 2 signaling). The positioning related information may comprise one or more of the following information fields:
a SL PRS presence field to indicate the presence of a SL PRS.
a SL PRS identification field that may include one or more of: a starting symbol for SL PRS, a number of symbols for SL PRS, a comb index for SL PRS, a starting physical resource block (PRB) for SL PRS, a number of PRBs or number of subchannels for SL PRS, a SL PRS resource index, a SL PRS resource set index, a SL PRS repetition index, and/or a number of repetitions for SL PRS transmission.
a PSCCH DMRS field that may indicate the presence of a DMRS with PSCCH resources of the shared resource pool, if used for positioning.
a PSSCH DMRS field that may indicate the presence of a DMRS with PSSCH resources of the shared resource pool, if used for positioning.
an Indication of DMRS symbol field to identify a symbol to be used for receiver (Rx) timing estimation.
an Information field to identify which DMRS layer may be used for positioning.
a CSI-RS field to indicate a presence of a CSI-RS, if used for positioning.
a Transmission time information field to indicate a time of transmission.
a Preceding reception time information field to indicate a time of a preceding reception.
an RTT Information field to indicate how to respond to the position information for RTT based ranging.
a field to indicate which transmission in the future will be used for SL PRS.
a field to indicate a whether the transmission for SL PRS is transmitter periodically.
One or more Indication fields to indicate presence of automatic gain control (AGC) and/or guard symbol between SL PRS resources within the SL PRS resource pool.

In another embodiment, the resource logic circuitry of the UE 211 may communicate the positioning related information via RRC based signaling. The positioning related information may comprise one or more of the following information fields:
a SL PRS presence field to indicate the presence of a SL PRS.
a SL PRS identification field that may include one or more of: a starting symbol for SL PRS, a number of symbols for SL PRS, a comb index for SL PRS, a starting physical resource block (PRB) for SL PRS, a number of PRBs or number of subchannels for SL PRS, a SL PRS resource index, a SL PRS resource set index, a SL PRS repetition index, and/or a number of repetitions for SL PRS transmission.
a PSCCH DMRS field that may indicate the presence of a DMRS with PSCCH resources of the shared resource pool, if used for positioning.
a PSSCH DMRS field that may indicate the presence of a DMRS with PSSCH resources of the shared resource pool, if used for positioning.
an Indication of DMRS symbol field to identify a symbol to be used for receiver (Rx) timing estimation.
an Information field to identify which DMRS layer may be used for positioning.
a CSI-RS field to indicate a presence of a CSI-RS, if used for positioning.
a Transmission time information field to indicate a time of transmission.
a Preceding reception time information field to indicate a time of a preceding reception.
an RTT Information field to indicate how to respond to the position information for RTT based ranging.
a field to indicate which transmission in the future will be used for SL PRS.
a field to indicate a whether the transmission for SL PRS is transmitter periodically.
One or more Indication fields to indicate presence of automatic gain control (AGC) and/or guard symbol between SL PRS resources within the SL PRS resource pool.

In many embodiments, the resource logic circuitry of the UE 211 may perform different measures to perform SL positioning. In some embodiments, single sided RTT, double sided RTT, SL-AoA, and SL-TDoA (in Rx) may be applicable for shared resource pools. SL-TDoA (in Rx) is a method such as UL-TDoA on the Uu interface where a UE such as UE 211 is transmitting, and multiple (highly synchronized) other devices (such as target UEs and/or anchor UEs in FIG. 1B) receive this signal and perform positioning based on the time difference of arrival. Note that from the perspective of SL resource allocation, these latter positioning techniques may be categorized into two categories: single shot transmissions and transmission with response. Single sided RTT, SL-AoA, and SL-TDoA (in Rx) may, in some embodiments, all fall within single shot transmissions. In some embodiments, the double sided RTT may comprise a transmission followed by a response from the receiving node or base station 201 (such as the AN or base stations shown in FIGS. 1A-1C).

For shared resource pool single shot positioning transmissions, the resource logic circuitry of the UE 211 may support both periodic and aperiodic transmissions. For instance, in one embodiment, the resource logic circuitry of the UE 211 may support SL resource allocations for periodic SL PRS transmissions for single shot positioning transmissions. The resource logic circuitry of the UE 211 may use the same mechanism as the communication transmissions for resource allocation and may perform SL resource allocations based on full sensing, partial sensing, or random resource allocation. Different resource allocation parameters can be defined for mode-2 resource allocation for SL PRS transmission. All or a subset of parameters defining the resource allocation such as a resource selection window may be defined for the SL positioning transmissions. In some embodiments, only a subset of all periodicities defined for communication are applicable for SL PRS transmissions.

In another embodiment, the resource logic circuitry 240 of the UE 211 may support aperiodic transmissions including blind and/or HARQ for single shot positioning transmissions. In some embodiments, the resource logic circuitry 240 of the UE 211 may support SL resource allocation using the same mechanism as the communication transmissions and may support SL resource allocation based on full sensing, partial sensing, or random resource allocation for aperiodic transmissions. The resource logic circuitry 240 of the UE 211 may define all or a subset of parameters defining the resource allocation such as a resource selection window for the SL positioning transmissions. In some embodiments, the resource logic circuitry 240 of the UE 211 may define only a subset of all periodicities defined for communication for SL positioning transmissions. In further embodiments, the HARQ may, for instance, indicate that the positioning measure did not reach sufficient accuracy.

In another embodiment, the resource logic circuitry 240 of the UE 211 may process multiple single sided RTT measurements from one transmitting UE (such as a target UE or the UE-2 in FIGS. 1A-1C) to enable TDoA in combination with the knowledge of the incurred movement of the UE between these measurements. In other words, the UE may measure or track movements its movements. Such tracking of the UE location may be possible based on maintenance of a time synchronization or time difference information by the transmitting UE. The resource logic circuitry 240 of the UE 211 may combine the time difference with the UE trajectory (or movements) to estimate the relative position to the transmitting UE. If the absolute position of one or more of the transmitting UEs is known, the resource logic circuitry 240 of the UE 211 may perform positioning with a high accuracy.

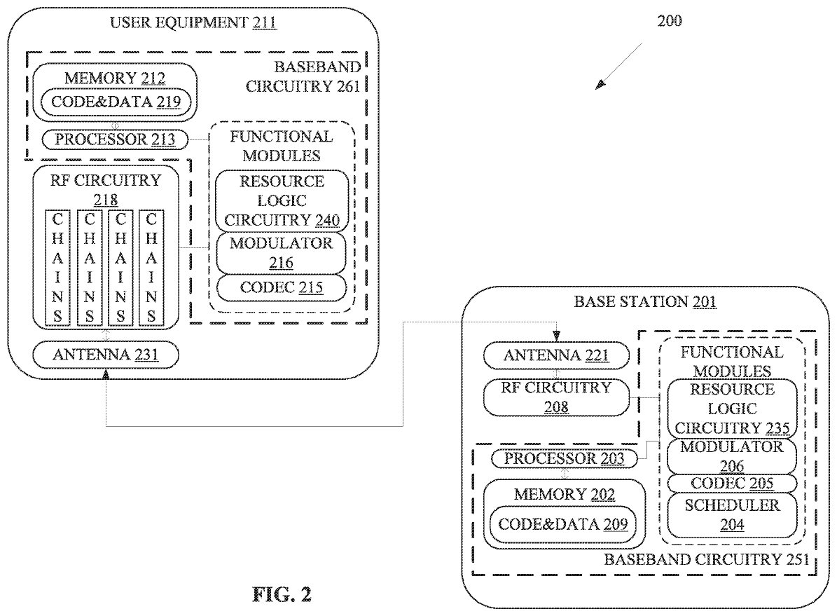

In another embodiment, the resource logic circuitry 240 of the UE 211 may support SL resource allocation for double sided RTT for either or both periodic and aperiodic transmissions. In many embodiments, the SL resource allocations for the two transmissions may be as close as possible in time. FIG. 3 depicts an embodiment of a graph 300 showing positioning error due to movement between RTT transmissions communications. The graph 300 shows that if the time between both transmission for RTT based ranging is too large, the ranging error introduced as the UEs move between both transmissions may introduce a significant additional error. Thus, the resource logic circuitry 240 of the UE 211 may ensure relatively small time gaps between two transmissions via a design parameter defined as t_{maxRTT}.

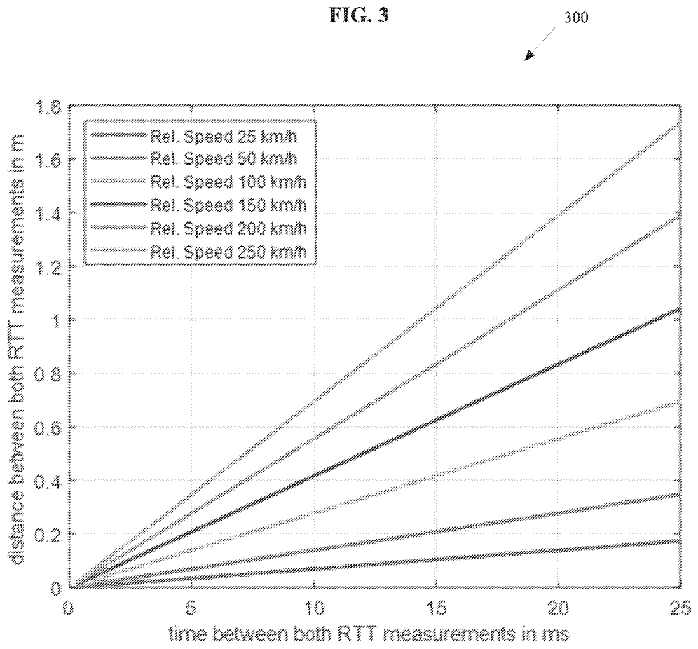

FIG. 4A depicts an embodiment 400 of a periodic SL resource allocation by resource logic circuitry of a UE 1 such as the resource logic circuitry 240 of the UE 211 shown in FIG. 2 to periodically transmit positioning information related to an initial transmission for RTT. The resource logic circuitry of other UEs may detect that UE 1 is periodically transmitting positioning information for RTT. The resource logic circuitry of other UEs may then respond to an upcoming periodic transmission occasion by autonomously allocating SL resources from one of one or more shared resource pools via random selection for a response with their own RTT response message. The resource logic circuitry of such responding UEs may perform the related random selection of SL resources from the one or more shared resource pools for a response, taking into account the maximum distance of two RTT transmissions. Based on the knowledge of the SL resources for the periodic RTT transmission of positioning information, the resource logic circuitry of the responding UEs may setup a resource (re)-selection trigger and a remaining time budget for responding such that the resulting resource selection window (RSW) is limited to within the maximum time distance between the periodic RTT transmission and the transmission of the response

In the embodiment 400, considering that the transmissions occur in a shared resource allocation pool (s-pool) for RTT, the resource logic circuitry of the UE may transmit all necessary information within the PSSCH alongside with the periodic transmission. The signal flow (including necessary timestamps) is shown in FIG. 4B.

FIG. 4B shows communications 410 between a roadside unit (RSU)) and a UE such as the UEs in FIGS. 1A-C, and 2. Note that the RSU may be an anchor UE such as the UEs in FIGS. 1A-C, and 2. At time t1, the RSU may transmit a periodic transmission with position information that arrives at the UE at time t2. Note that as SL is based on absolute synchronization, the time understanding of the transmitting UE for the start of the transmission containing the reference symbols used for positioning is known at the receiving UE. This assumes that the transmitting UE is aware of all delays incurred in the signal path before the resulting EM-wave is transmitted at the antenna and is properly compensating for the delays.

The resource logic circuitry of the UE may, having sensed the periodic RTT transmission, allocation SL resources from a shared resource pool to respond to the periodic transmission with a response transmission that comprises positioning information. The response from the UE may arrive at the RSU at time t4. After the RSU receives the response from the UE at time t4, the resource logic circuitry of the RSU may transmit any additional information towards the UE to facilitate ranging or positioning. The additional information may include one or more fields with the following information:
The time difference t_4-t_1.
The timestamp t_4.
Accuracy of the time difference or the timestamps.
The location of the RSU.
Accuracy or confidence level of the position of the RSU.
Additional positioning information that can be used other UEs in the vicinity to facilitate positioning.

FIG. 4C shows another embodiment 420 for SL resource allocation in a shared resource pool (s-pool) for aperiodic transmissions for RTT-based ranging/positioning. A resource logic circuitry of a UE 2 may be configured to respond to an initial transmission for RTT-based ranging/positioning either in an ad hoc fashion after receiving the information from UE 1 using a SL RSW for selecting shared pool resources or after the resource allocation circuitry of the UE1 allocates SL resources to transmit an SCI to UE 2 to inform UE 2 that the next transmission originating from the UE 1 has a target resource allocation to initiate an RTT exchange. Note that in this case, it may be desirable that the earliest available resource is prioritized for the responding transmission. In some embodiments, the resource logic circuitry of the UE 2 may define a priority for acquisition of a resource from the shared resource pool within the RSW.

FIG. 4D shows another embodiment 430 for SL resource allocation in a shared resource pool (s-pool) for aperiodic transmissions for RTT-based ranging/positioning. For embodiment 430, the resource logic circuitry of UE 1 and the resource logic circuitry of UE 2 may negotiate and agree on the time or resource location or RSWs used for the RTT based transmission via higher layers such as the RRC. Such parameters may be adjusted to ensure that the maximum time difference between both transmissions is not longer than t_{maxRTT}.

FIG. 4E shows another embodiment 440 for SL resource allocation in a shared resource pool (s-pool) for aperiodic transmissions for RTT-based ranging/positioning. For embodiment 440, the resource logic circuitry of UE 1 and the resource logic circuitry of UE 2 may negotiate and agree on the roles of the initiating and responding UEs via higher layer signaling such as the RRC. The initiating UE 1 may transmit an initial transmission that is allocated as a transmission with two transmission occasions. In this case, the resource logic circuitry of the responding UE 2 may know in advance when the second transmission may occur and can adjust its own resource allocation to have the RSW right after this transmission. Also, in this case it may be beneficial if in the resource determination there is a bias towards earlier in time resources.

FIG. 4F shows another embodiment 450 for SL resource allocation in a shared resource pool (s-pool) for aperiodic transmissions for RTT-based ranging/positioning. For embodiment 450, the resource logic circuitry of UE 1 and the resource logic circuitry of UE 2 may negotiate and agree on roles of initiating and responding UEs via higher layer signaling such as the RRC. Subsequently, the initiating UE 1 may transmit using multiple transmissions, wherein the SCI used for a first transmission is also used to reserve the resource for a second transmission. The responding UE 2 can know when the second transmission may occur and trigger the resource (re)-selection at an appropriate time to have the RSW start right after the initial transmissions of UE 1.

FIG. 4G shows another embodiment 460 for SL resource allocation in a shared resource pool (s-pool) for aperiodic transmissions for RTT-based ranging/positioning. For embodiment 460, the resource logic circuitry of UE 1 and the resource logic circuitry of UE 2 may negotiate and agree on a location of an RSW via higher layer signaling such as the RRC. In some embodiments, the resource logic circuitry of the UEs may further determine usage of slots for transmissions between the two UEs, e.g., the UE 1 may use only odd-numbered slots for transmission and the UE 2 may use only even-numbered slots for transmission, or vice versa. This can be implemented either during a resource (re)-selection procedure or in a MAC layer resource determination. In such embodiments, it is also of advantageous if both UEs have the same bias towards early or late or any other clearly defined resources in the RSW.

FIG. 4H shows an embodiment 470 for a message sequence for SL resource allocation in a shared resource pool (s-pool) for aperiodic transmissions for RTT-based ranging/positioning. For embodiment 470, the resource logic circuitry of UE 1 and the resource logic circuitry of UE 2 may negotiate and agree on a location of an RSW via higher layer signaling such as the RRC. Note that in this and some of the above embodiments and examples, it is assumed that a unicast connection has already been established. After a unicast connection is established, the resource logic circuitry of the UE1 and the UE2 may exchange RRC based messages. The RRC messages may organize the RTT based exchange and may include one or more fields with one or more of the following information:
Time location of the RSW for both UEs.
Identifying the initiating and responding UEs.
Mode for the aperiodic RTT message/information exchange.
RSW for the initial transmission.
Which UE may use even-numbered and which UE may use odd-numbered slots.
Length of the RSW in slots.

After the aperiodic resource allocation (RA) mode for the RTT exchange is defined, the resource logic circuitry of the UEs may initiate the resource allocation mode according to the exchanged information. To facilitate ranging and potentially positioning after the exchange, the resource logic circuitry of the UE 1 may send all necessary positioning information to the resource logic circuitry of UE 2 and vice versa. For instance, the UE 1 may transmit an RRC message for aperiodic positioning resource allocation and the UE 2 may respond with an acknowledgement (ACK) for the aperiodic positioning resource allocation. The UE1 may, if needed, transmit an initial transmission to the UE 2 and then may transmit a transmission with positioning information at time t1 that is received by the UE 2 at time t2. The UE2 may transmit a response to the transmission with positioning information at time t3 that arrives at the UE 1 at time t4. Thereafter the UE 1 may transmit remaining UE 1 information to facilitate ranging and after receipt, the UE2 may respond with additional UE 2 information to facilitate ranging.

FIG. 4I shows an embodiment 480 for multiplexing of PSCCH/PSSCH and SL PRS in a shared resource pool. Note that the SL PRS is only present in OFDM symbols without PSSCH DMRS. For shared resource pools, resource logic circuitry of a UE may not map SL PRS and PSSCH DMRS in the same OFDM symbol(s). The same design principle may be applied if SL PRS collides with PT-RS in the same symbol. In particular, resource logic circuitry of a UE may not map SL PRS and PT-RS in the same OFDM symbol for a shared resource pool.

Referring again to FIG. 2, the resource logic circuitry 240 of the UE 211 may support scheme 2 SL resource allocation from a dedicated resource pool (d-pool). In some embodiments, the scheme 2 resource allocation for a dedicated positioning resource pool may be based on long- and/or short-term sensing of the available resources. This can include pre-reservation, blind retransmissions, and sensing of periodic and aperiodic transmissions.

In another embodiment, the resource logic circuitry 240 of the UE 211 may share the reservation information for periodic and/or aperiodic transmissions of positioning resource in a dedicated resource pool with other UEs via one or more of:
SCI in a dedicated resource pool
SCI in a shared resource pool.
MAC CE in a dedicated resource pool
MAC CE in a shared resource pool.
RRC signaling in a dedicated resource pool
RRC signaling in a shared resource pool.
PC5 user plane signaling.
Uu control or user plane signaling

In the above, the SCI may correspond to only stage-1 SCI or both stage-1 and stage-2 SCI. Further, the resource logic circuitry 240 of the UE 211 may share information via broadcast, groupcast or unicast transmissions.

In another embodiment, the resource logic circuitry 240 of the UE 211 may use all or a subset of the following information is used for the sensing for the scheme 2 resource allocation in a dedicated positioning resource pool:
Periodic reservations, potentially including the number of periodic transmission occasions that are planned to be used signaled via
   SCI in a dedicated resource pool
   SCI in a shared resource pool
   MAC CE in a dedicated resource pool
   MAC CE in a shared resource pool
   RRC signaling in a dedicated resource pool
   RRC signaling in a shared resource pool
   PC5 user plane signaling
   Uu control or user plane signaling
Aperiodic reservations (potentially multiple) signaled via
   SCI in a dedicated resource pool
   SCI in a shared resource pool
   MAC CE in a dedicated resource pool
   MAC CE in a shared resource pool
   RRC signaling in a dedicated resource pool
   RRC signaling in a shared resource pool
   PC5 user plane signaling
   Uu control or user plane signaling

In the above, SCI may correspond to only stage-1 SCI or both stage-1 and stage-2 SCI.

In another embodiment, the resource logic circuitry 240 of the UE 211 may perform the resource selection procedure for a dedicated resource pool based on sensing information to construct a set of candidate resource, wherein potential SL PRS resources within the dedicated resource pool within a determined resource selection window. Afterwards, the resource logic circuitry 240 of the UE 211 may exclude resources in, e.g., an iterative procedure. The iterative procedure for exclusion may end after a certain amount of resources are achieved. The resource selection window (RSW) may be defined by a (pre)-configured value in combination with latency constraints, if applicable.

The resource exclusion procedure may be based on one or more of:
Excluding reserved positioning resource
Excluding reserved positioning resource based on reference signal received power (RSRP) of the related transmission
RSRP of the related PSCCH DMRS
RSRP of the related PSSCH DMRS if the resource reservation is carried via a PSSCH.

The maximum number of resources that a UE may select from a resource pool may be (pre)-configured from based on one or more of the following parameters:
A (pre)-configured absolute number of resources
An application specific number of resources
A percentage of the number of available resources rounded up
A percentage of the number of available resources rounded down

In another embodiment, the resource logic circuitry 240 of the UE 211 may reselect a previously reserved resource if a conflicting reservation is detected. In this case, a priority for reserving the reserving conflicting resource allocation may resolved based on one or more of:
Higher physical layer source (SRC) ID
Lower physical layer SRC ID
Higher physical layer destination (DST) ID
Lower physical layer DST ID
Earlier transmission of the resource reservation
Later transmission of the resource reservation
Prioritization of periodic reserved resources over aperiodic ones
Prioritization of aperiodic reserved resources over periodic ones

In another embodiment, the resource logic circuitry 240 of the UE 211 may provide resource allocation information for SL PRS transmissions from a second UE and/or for SL PRS reception at a third UE. In some embodiments, the first UE may provide such information to coordinate transmissions from multiple other UEs, wherein such information may comprise one or more of: indication of resource reservation, resource occupancy information, prioritization of certain resources, or preemption of use of certain resources. the resource logic circuitry 240 of the UE 211 may signal the SL PRS resource assignment for transmission and/or reception and/or configuration for resource coordination via one or more of: unicast, broadcast, or groupcast transmissions using one or more of the following:
SCI in a dedicated resource pool
SCI in a shared resource pool
MAC CE in a dedicated resource pool
MAC CE in a shared resource pool
RRC signaling in a dedicated resource pool
RRC signaling in a shared resource pool
Power control (PC)-PC5 user plane signaling
Control signaling through the network
User plane signaling via the network

In one embodiment, the resource logic circuitry 240 of the UE 211 may coordinate with one or more other UEs within its communication range on the resource assignments for SL PRS transmissions from multiple UEs to prevent resource assignment conflicts and collisions between DL PRS from different UEs. In some embodiments, the set of potential transmitting UEs may be same as or have no overlap or have partial overlap with the set of coordinating UEs. The resource logic circuitry 240 of the UE 211 may achieve the alignment between the coordinating UEs via message exchanges using one or more of the following interfaces:
PC5 broadcast of the resource assignment for the participating devices assuming other coordinating UEs also receive these messages
PC5 resource pool user plane used for general communication
PC5 resource pool user plane dedicated for such coordination
PC5 control plane
Using the data plane of the network.
Using the control plane of the network
Any other communication interface between these coordinating UEs

In another embodiment, the content of the single or two stage SCI may contain any combination of the following fields, which is carried by PSCCH or PSSCH in the resource pool.
Priority of the SL PRS transmission
SL PRS resource index, or SL PRS resource set index,
SL PRS time and frequency resources, potentially for multiple past and future resources
   In case of indicating past resources, an index of the resource or a sign of a time offset may be also present
SL PRS comb offset ID
Resource reservation period
Reserved bits
Sequence ID for SL PRS
Cast type indicator
MCS (or code rate for 2nd stage SCI)
Beta Offset
Source ID
Destination ID
2nd stage SCI format (for dedicated SL PRS pool)
DMRS port and pattern Configuration
Repetition index of SL PRS transmission;
Number of SL PRS repetitions.
Indication of presence of AGC and/or guard symbol between SL PRS resources within the SL PRS resource pool.

In another embodiment, the resource logic circuitry 240 of the UE 211 may define a (pre)-configured number of priority levels for SL PRS and may associate a SL PRS with one priority level. the resource logic circuitry 240 of the UE 211 may define the number of priority levels on a resource pool basis or for all dedicated resource pools for SL PRS associated with a SL BWP. In some embodiments, the resource logic circuitry 240 of the UE 211 may define an integer number of priority values. In some embodiment, the resource logic circuitry 240 of the UE 211 may indicate the number of priority levels using 1, 2, or 3 bits resulting in 2, 4, or 8 different priority values, respectively. In some embodiments, the resource logic circuitry 240 of the UE 211 may not configure a priority and the related information fields are omitted.

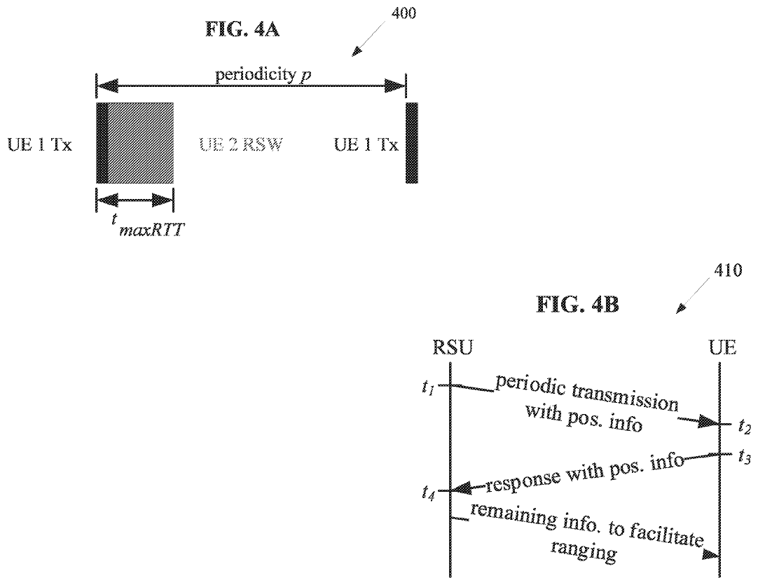

FIG. 5A shows an embodiment 500 for examples of different frequency allocation options for SL PRS frequency resource for a dedicated resource pool. The resource logic circuitry 240 of the UE 211 may define the frequency resources of the SL PRS in terms of their bandwidth. This implies that a definition in either sub-channels of pre-defined size in terms of PRBs, or portions of a band. Note it is also possible that resource logic circuitry 240 of the UE 211 may define only full bandwidth allocation of the SL PRS in a dedicated SL PRS resource pool. In some embodiments, resource logic circuitry 240 of the UE 211 may be preconfigured to define for one or more dedicated resource pools, whether an SL PRS allocation may be allocated a maximum bandwidth that is be smaller than the bandwidth of the resource pool, and, if so, a granularity of allocation, or whether an SL PRS allocation from the resource pool is restricted to have the same bandwidth as the resource pool. Note that for sub-channels it is possible that the remainder of the PRBs are added to the last sub-channel, distributed to all sub-channels, or as in the SL communication case, not used. For the “pool fraction” case, the remainder of the PRBs may also be added to the last fraction of the pool, distributed among all fractional parts, or not used. In the full pool case, all SL PRS frequency resources are allocated towards the SL PRS, and no fractional allocation is possible.

In another embodiment, the number of time resource that are available per slot for different SL PRS transmission may define the granularity of the time domain resource allocation and resource logic circuitry 240 of the UE 211 may be (pre)-configured per resource pool to enable proper sensing and multiplexing of these resources. The term logical SL PRS resource is used to define an indexing of the available SL PRS resource. In case there is only one SL PRS per logical slot in the dedicated SL PRS pool it is the same as a logical slot. In case there are multiple SL PRS resources per slot, resource logic circuitry 240 of the UE 211 may increment the index for the logical SL PRS resource accordingly.

In another embodiment, resource logic circuitry 240 of the UE 211 may be (pre)-configured per SL PRS resource pool with the number of resources in different slots or mini slots that can be simultaneously signaled.

In another embodiment, resource logic circuitry 240 of the UE 211 may signal together in a single value, the time and frequency resources for SL PRS mapped to multiple slots. The value may signal a combination of one or more of: the number of frequency resources, the number of time resources, the index of the frequency resources and the number of total resources in different time slots. Note that, in some embodiments, resource logic circuitry 240 of the UE 211 may mandate that the frequency location of all frequency resources in different slots is the same. In such embodiments, resource logic circuitry 240 of the UE 211 may not be necessary to signal that that the same frequency location of all frequency resources in different slots is the same.

In another embodiment, resource logic circuitry 240 of the UE 211 may signal separately, the time and frequency resources for SL PRS mapped to multiple slots. The time location may contain one or both of: a number of signaled time resource in the current SCI and their location within a time window. In some embodiments, resource logic circuitry 240 of the UE 211 may define the time window in a number of logical slots starting from the slot in which the SCI is transmitted. The frequency resource may indicate one or both of: the number of allocated frequency resources and their starting position. The starting position in the current slot could also be determined implicitly from the location of the PSCCH in the dedicated SL PRS resource pool slot. Note that it is also possible that the same frequency location of all frequency resources in different slots is mandated to be the same, thus it may not be necessary to signal it.

FIG. 5B shows an embodiment 510 of time allocation within a window W for a dedicated resource pool. The resource logic circuitry 240 of the UE 211 may signal the time resource as well the number of resources in different logical SL PRS resource within a window of W logical SL PRS resource with the following indexing value: That is, a combinatorial index r corresponding to N logical SL PRS indexes from the window W, with

$${\{ {l}_{i} \}}_{i = 0}^{M} , ( 1 \leq {l}_{i} \leq M , {l}_{i} < {l}_{i + 1} )$$

and given by equation

$${\sum }_{i = 0}^{N - 1} 〈 \begin{matrix}M - {l}_{i} \\ N - {l}_{i}\end{matrix} 〉 , where 〈 \begin{matrix}y \\ y\end{matrix} 〉 = \{ \begin{matrix}( \begin{matrix}x \\ y\end{matrix} ) & x \geq y \\ 0 & x < y\end{matrix}$$

is the extended binomial coefficient, resulting in unique label

$$r ∈ \{ 0 , … , ( \begin{matrix}M \\ N\end{matrix} ) - 1 \} .$$

The values lᵢ represent the offset in terms of logical SL PRS resource indexes wherein SL PRS resources are indexed in ascending order of first symbols within the time window W and the time offset for a SL PRS resource is indicated relative to the preceding allocation.

In another embodiment, resource logic circuitry 240 of the UE 211 may signal separately, the frequency resource for each SL PRS. The indication may contain the number of frequency resources as well as their location for different special cases. To explain, resource logic circuitry 240 of the UE 211 may define the following parameters:
Number of available sub-channels in a slot: N_{FR}
Number of resources signaled beyond the first: n
Number of allocated frequency resource: m
List of frequency resource start indices in a slot k₀, . . . , kₙ₋₁

Assuming prior knowledge of these parameters and under the assumption that m stays the same for each allocation, the general index to define the frequency resource indicator, d may be defined as:

$$d = \{ \begin{matrix}{\sum }_{j = 0}^{n} {( {N}_{FR} + 1 - m )}^{j} {k}_{j} & n > 0 \\ {N}_{FR} ( m - 1 ) + {k}_{0} & n = 0\end{matrix}$$

For the case that the index of the first resource can be inferred from the position of the control channel and under the assumption that m stays the same for each allocation, the index may be defined as

$$d = \{ \begin{matrix}{\sum }_{j = 0}^{n - 1} {( {N}_{FR} + 1 - m )}^{j} {k}_{j} & n > 0 \\ m - 1 & n = 0\end{matrix}$$

For the case that the index of each frequency resource stays the same and under the assumption that m stays the same for each allocation, d=N_{FR}(m−1)+k₀.

For the case that the index of each frequency resource stays the same, the index of the first frequency resource can be inferred from the location of the control channel, and under the assumption that m stays the same for each allocation, d=(m−1).

FIG. 5C shows an embodiment 520 of multiplexing of PSCCH and SL PRS in a dedicated resource pool. The resource logic circuitry 240 of the UE 211 may only a single stage SCI for a dedicated resource pool for SL positioning when multiplexing in the dedicated resource pool. PSCCH and associated SL PRS are time division multiplexed in the same slot. As illustrated in the embodiment 520, as the transmission bandwidth of PSCCH and SL PRS is generally different, an AGC symbol may need to be inserted between PSCCH and SL PRS to ensure proper operation at receiver side.

FIG. 5D shows an embodiment 530 of one-to-one mapping between PSCCH subchannel and SL PRS resource in a dedicated resource pool. A SL PRS resource refers to a time-frequency resource within a slot of a dedicated SL PRS resource pool that is used for SL PRS transmission, which is identified by a SL PRS resource ID that is unique within a slot of a dedicated SL PRS resource pool. Further, in a dedicated resource pool, one subchannel which consists of contiguous PRBs can be configured for PSCCH transmissions. This allows for the reuse of the PSCCH design for SL communication, thereby minimizing implementation and specification efforts.

As defined for SL communication, the lowest sub-channel for sidelink transmission is the sub-channel on which the lowest PRB of the associated PSCCH is transmitted. To facilitate SL PRS resource allocation in a dedicated resource pool, it may be more appropriate to support a mapping between subchannel index used for the PSCCH transmission and associated SL PRS resource index, which can help reduce the signaling overhead. In this case, explicit indication of a SL PRS resource in a dedicated resource pool is not needed in the single stage SCI.

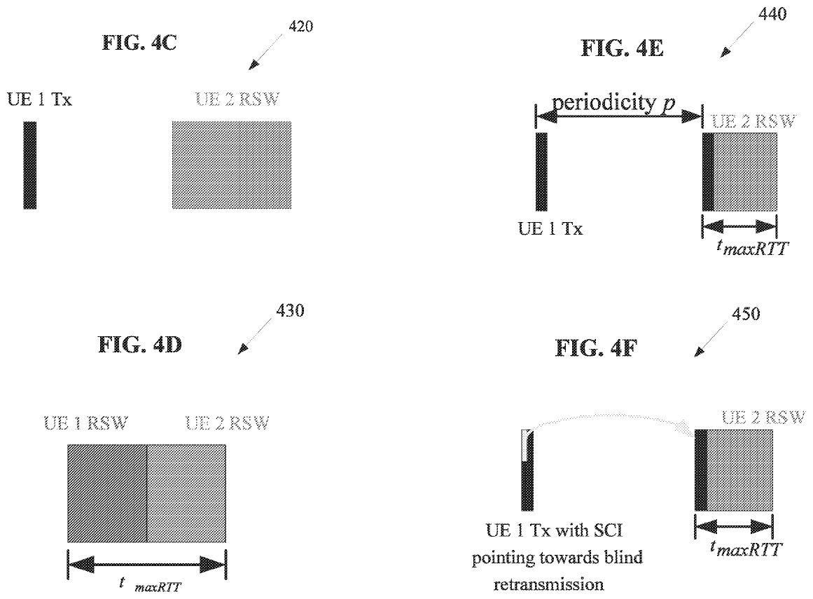

FIG. 6 depicts a flowchart 6000 for a UE to allocate SL resources for sidelink communications such as the embodiments described in conjunction with FIGS. 1A-1C, 2-3, 4A-I, and 5A-5E. At the beginning of the flowchart 6000, a first UE perform resource selection from a resource pool to determine a set of resources from the resource pool for transmission of a reference signal in a physical sidelink shared channel (PSSCH) (element 6005). For example, the first UE may be an anchor UE or a transmitting UE and perform resource allocation to obtain positioning and, optionally, ranging information from a target UE. The first UE may be configured (possibly preconfigured) with one or more shared resource pools and/or one or more dedicated resource pools for scheme 2 SL positioning. In preparation for performing the resource allocation, the first UE may have monitored one or more frames or subframes of a frame to locate the set of resources for allocation. In some embodiments, the first UE may perform a full sensing-based resource selection. In other embodiments, the first UE may perform partial sensing-based resource allocation. In still other embodiments, the first UE may perform random-based resource allocation.

After selecting the set of resources, the first UE may autonomously allocate the set of resources for a transmission of the reference signal within the PSSCH (element 6010). In some embodiments, the first UE may reserve the set of resources with a group of one or more coordinating UEs. In some embodiments, the first UE may include a priority with a reservation request to reserve the selected set of resources. In some embodiments, the first UE may include priority related information with the priority request. For instance, the priority for the reservation may be based configured (possibly preconfigured) priority levels for transmission of a reference signal such as a SL PRS. In some embodiments, priority levels based on the configuration of the resource pool or pools within which the set of resources reside. As an example, a dedicated resource pool may have a different priority level than a shared resource pool, a first shared resource pool may have a different priority than a second shared resource pool, and/or a first dedicated resource pool may have a different priority than a second dedicated resource pool. As another example, a priority level may relate to the reservation type in that an aperiodic reservation may have a different priority level than a periodic reservation. Note that any one or all these characteristics may affect the priority level, i.e., the periodicity of reservation, the specific pool or pools associated with the reservation, the signaling associated with the reservation, or even the subframes within which the set of resources reside.

After allocation of the set of resources, the first UE may generate a control information signal to signal the set of resources for the reference signal, the control information signal comprising a source identifier field, a destination identifier field, and one or more fields to indicate automatic gain control, guard symbols, or a combination thereof (element 6015). In some embodiments, the control information signal may comprise a SL PRS. In further embodiments, the control information signal may comprise a DMRS. In still other embodiments, the control information signal may comprise a CSI-RS. In many of these embodiments, the control information signal may comprise layer 1 signaling. In some of these embodiments, the layer 1 signaling may comprise information from higher layers such as the RRC layer.

Once the first UE generates the control information signal, the first UE may encode the control information signal for transmission (element

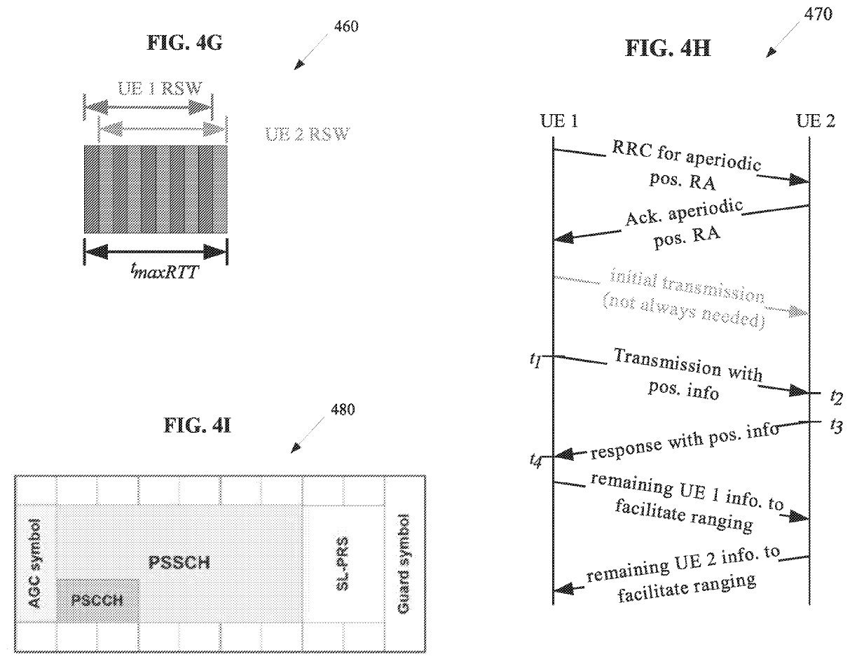

FIG. 7 depicts a flowchart 7000 for sidelink (SL) positioning by a UE such as the embodiments described in conjunction with FIGS. 1A-1C, 2-3, 4A-41, 5A-5D, and 6. More specifically, the flowchart 7000 may illustrate a UE to receive and respond to SL positioning. At the beginning of the flowchart 7000, the UE may decode a control information signal to determine the set of resources for the reference signal, the control information signal comprising a source identifier field, a destination identifier field, and one or more fields to indicate automatic gain control, guard symbols, or a combination thereof (element 7005). In some embodiments, the UE may receive a control information signal indicative of a subsequent reference signal for SL positioning. In some embodiments, the UE may receive a reference signal for SL positioning and ranging but be unable to respond in sufficient time to perform positioning and ranging.

After receiving and decoding the control information signal or prior to receiving the control information signal, the UE may reserve resources from a shared pool of resources or a dedicated pool of resources for responding to a reference signal. After receipt of the reference signal, the UE may decode the reference signal in a physical sidelink shared channel (PSSCH) based on values in one or more fields in the control information signal (element 7010) and generate a response to the reference signal with measurements, calculations, and/or other position related information relating to informing the transmitting UE positioning information for the UE.

After or during the generation of the response, the UE may begin encoding the response to receipt of the reference signal with the positioning information (element 7015). In some embodiments, the transmitting UE may be performing positioning and ranging with RTT. To perform the ranging, the transmitting UE may respond to the positioning information with additional positioning information for ranging.

To perform the ranging calculations, the UE may need to respond to the reference signal within a short period of time after receipt of the reference signal so the UE may perform the resource reservations with a time limitation or restriction. The time limitation or restrict may limit the selection and reservation of resources from a pool of resources to only selecting or reserving resources that are within the time limitation or restriction of the resources used to transmit the reference signal. Otherwise, the selection or reservation may not occur close enough to the transmission of the reference signal to perform ranging within a predetermined margin of error or within a predetermined degree of accuracy. In other embodiments, the time limitation or restriction may be based on a degree of precision. In still other embodiments, the time limitation or restriction may be based on a degree of precision and a degree of accuracy.

In some embodiments, higher layers such as the RRC layer of the transmitting UE and the UE may negotiate communications and/or resources for coordinating the reservations of the transmitting UE and reservations of the UE such that the UE may reserve a RSW that is within the time limitation or time restriction. Such negotiations may facilitate positioning and ranging communications.

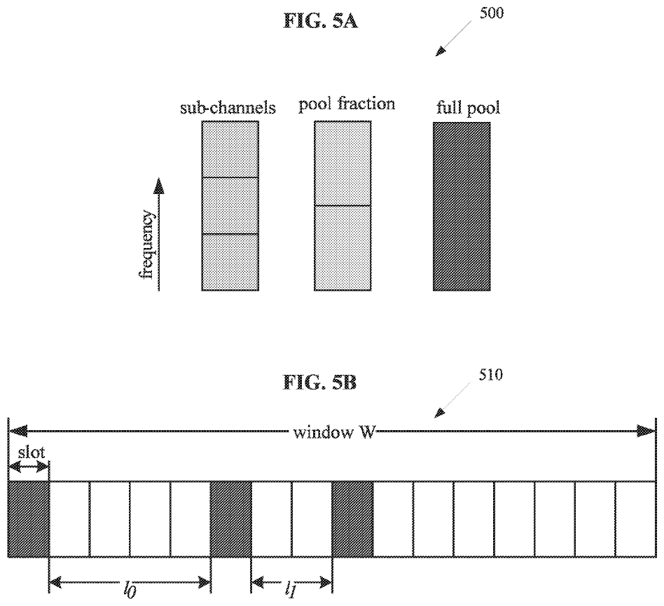

FIG. 8 depicts an embodiment of protocol entities 8000 that may be implemented in wireless communication devices, including one or more of a user equipment (UE) 8060, a base station, which may be termed an evolved node B (eNB), or a new radio, next generation node B (gNB) 8080, and a network function, which may be termed a mobility management entity (MME), or an access and mobility management function (AMF) 8094, according to some aspects.

According to some aspects, gNB 8080 may be implemented as one or more of a dedicated physical device such as a macro-cell, a femto-cell or other suitable device, or in an alternative aspect, may be implemented as one or more software entities running on server computers as part of a virtual network termed a cloud radio access network (CRAN).

According to some aspects, one or more protocol entities that may be implemented in one or more of UE 8060, gNB 8080 and AMF 8094, may be described as implementing all or part of a protocol stack in which the layers are considered to be ordered from lowest to highest in the order physical layer (PHY), medium access control (MAC), radio link control (RLC), packet data convergence protocol (PDCP), radio resource control (RRC) and non-access stratum (NAS). According to some aspects, one or more protocol entities that may be implemented in one or more of UE 8060, gNB 8080 and AMF 8094, may communicate with a respective peer protocol entity that may be implemented on another device, using the services of respective lower layer protocol entities to perform such communication.

According to some aspects, UE PHY layer 8072 and peer entity gNB PHY layer 8090 may communicate using signals transmitted and received via a wireless medium. According to some aspects, UE MAC layer 8070 and peer entity gNB MAC layer 8088 may communicate using the services provided respectively by UE PHY layer 872 and gNB PHY layer 8090. According to some aspects, UE RLC layer 8068 and peer entity gNB RLC layer 8086 may communicate using the services provided respectively by UE MAC layer 8070 and gNB MAC layer 8088. According to some aspects, UE PDCP layer 8066 and peer entity gNB PDCP layer 8084 may communicate using the services provided respectively by UE RLC layer 8068 and 5GNB RLC layer 8086. According to some aspects, UE RRC layer 8064 and gNB RRC layer 8082 may communicate using the services provided respectively by UE PDCP layer 8066 and gNB PDCP layer 8084. According to some aspects, UE NAS 8062 and AMF NAS 8092 may communicate using the services provided respectively by UE RRC layer 8064 and gNB RRC layer 8082.

The PHY layer 8072 and 8090 may transmit or receive information used by the MAC layer 8070 and 8088 over one or more air interfaces. The PHY layer 8072 and 8090 may further perform link adaptation or adaptive modulation and coding (AMC), power control, cell search (e.g., for initial synchronization and handover purposes), and other measurements used by higher layers, such as the RRC layer 8064 and 8082. The PHY layer 8072 and 8090 may still further perform error detection on the transport channels, forward error correction (FEC) coding/decoding of the transport channels, modulation/demodulation of physical channels, interleaving, rate matching, mapping onto physical channels, and Multiple Input Multiple Output (MIMO) antenna processing.

The MAC layer 8070 and 8088 may perform mapping between logical channels and transport channels, multiplexing of MAC service data units (SDUs) from one or more logical channels onto transport blocks (TB) to be delivered to PHY via transport channels, de-multiplexing MAC SDUs to one or more logical channels from transport blocks (TB) delivered from the PHY via transport channels, multiplexing MAC SDUs onto TBs, scheduling information reporting, error correction through hybrid automatic repeat request (HARQ), and logical channel prioritization.

The RLC layer 8068 and 8086 may operate in a plurality of modes of operation, including: Transparent Mode (TM), Unacknowledged Mode (UM), and Acknowledged Mode (AM). The RLC layer 8068 and 8086 may execute transfer of upper layer protocol data units (PDUs), error correction through automatic repeat request (ARQ) for AM data transfers, and concatenation, segmentation and reassembly of RLC SDUs for UM and AM data transfers. The RLC layer 8068 and 8086 may also execute re-segmentation of RLC data PDUs for AM data transfers, reorder RLC data PDUs for UM and AM data transfers, detect duplicate data for UM and AM data transfers, discard RLC SDUs for UM and AM data transfers, detect protocol errors for AM data transfers, and perform RLC re-establishment.

The PDCP layer 8066 and 8084 may execute header compression and decompression of Internet Protocol (IP) data, maintain PDCP Sequence Numbers (SNs), perform in-sequence delivery of upper layer PDUs at re-establishment of lower layers, eliminate duplicates of lower layer SDUs at re-establishment of lower layers for radio bearers mapped on RLC AM, cipher and decipher control plane data, perform integrity protection and integrity verification of control plane data, control timer-based discard of data, and perform security operations (e.g., ciphering, deciphering, integrity protection, integrity verification, etc.).

The main services and functions of the RRC layer 8064 and 8082 may include broadcast of system information (e.g., included in Master Information Blocks (MIBs) or System Information Blocks (SIBs) related to the non-access stratum (NAS)), broadcast of system information related to the access stratum (AS), paging, establishment, maintenance and release of an RRC connection between the UE and E-UTRAN (e.g., RRC connection paging, RRC connection establishment, RRC connection modification, and RRC connection release), establishment, configuration, maintenance and release of point to point Radio Bearers, security functions including key management, inter radio access technology (RAT) mobility, and measurement configuration for UE measurement reporting. Said MIBs and SIBs may comprise one or more information elements (IEs), which may each comprise individual data fields or data structures.

The UE 8060 and the RAN node, gNB 8080 may utilize a Uu interface (e.g., an LTE-Uu interface) to exchange control plane data via a protocol stack comprising the PHY layer 8072 and 8090, the MAC layer 8070 and 8088, the RLC layer 8068 and 8086, the PDCP layer 8066 and 8084, and the RRC layer 8064 and 8082.

The non-access stratum (NAS) protocols 8092 form the highest stratum of the control plane between the UE 8060 and the AMF 8005. The NAS protocols 8092 support the mobility of the UE 8060 and the session management procedures to establish and maintain IP connectivity between the UE 8060 and the Packet Data Network (PDN) Gateway (P-GW).

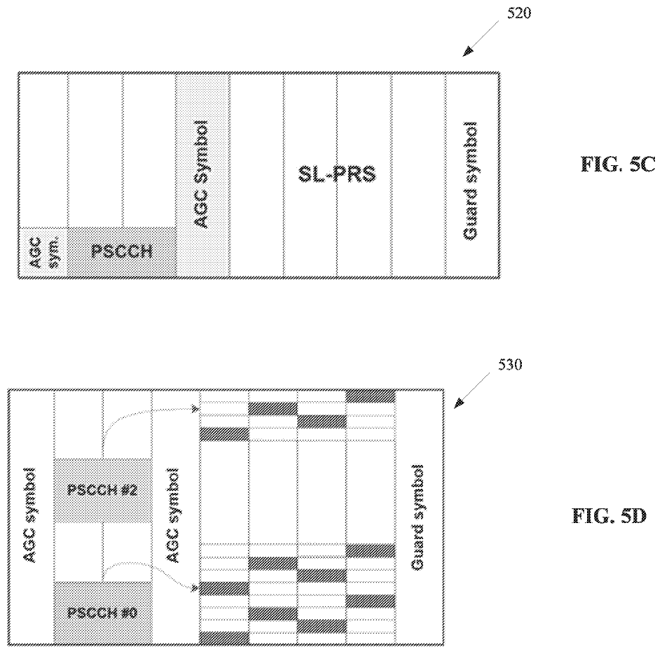

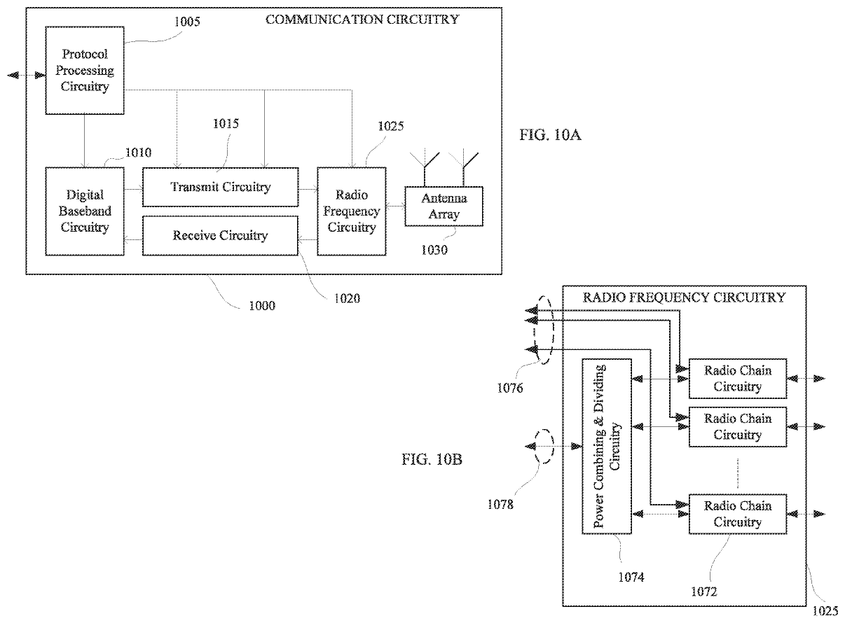

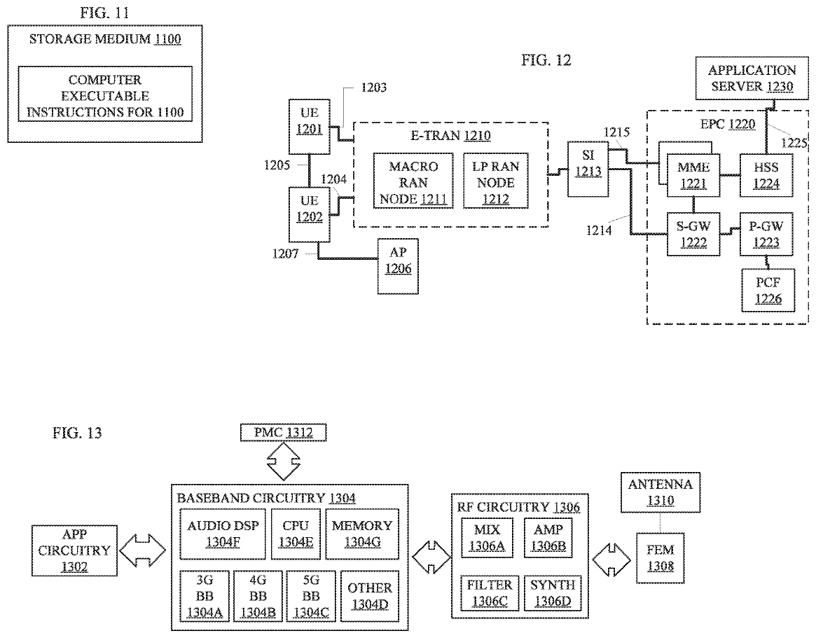

FIG. 9 illustrates embodiments of the formats of PHY data units (PDUs) that may be transmitted by the PHY device via one or more antennas and be encoded and decoded by a MAC entity such as the processors 203 and 213 in FIG. 2, the baseband circuitry 1304 in FIGS. 13 and 14 according to some aspects. In several embodiments, higher layer frames such as a frame comprising an RRC layer information element may transmit from the base station to the UE or vice versa as one or more MAC Service Data Units (MSDUs) in a payload of one or more PDUs in one or more subframes of a radio frame.

According to some aspects, a MAC PDU 9100 may consist of a MAC header 9105 and a MAC payload 9110, the MAC payload consisting of zero or more MAC control elements 9130, zero or more MAC service data unit (SDU) portions 9135 and zero or one padding portion 9140. According to some aspects, MAC header 8105 may consist of one or more MAC sub-headers, each of which may correspond to a MAC payload portion and appear in corresponding order. According to some aspects, each of the zero or more MAC control elements 9130 contained in MAC payload 9110 may correspond to a fixed length sub-header 9115 contained in MAC header 9105. According to some aspects, each of the zero or more MAC SDU portions 9135 contained in MAC payload 9110 may correspond to a variable length sub-header 9120 contained in MAC header 8105. According to some aspects, padding portion 9140 contained in MAC payload 9110 may correspond to a padding sub-header 9125 contained in MAC header 9105.

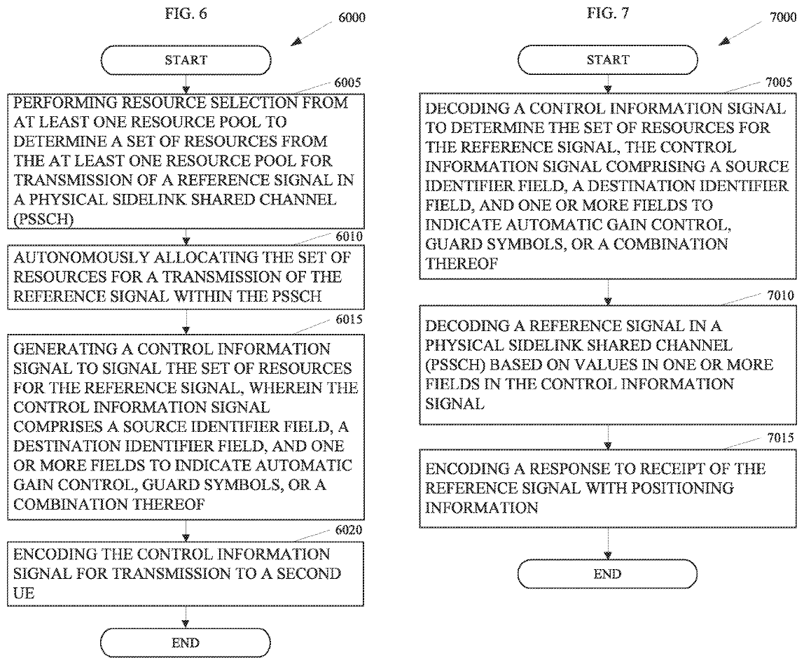

FIG. 10A illustrates an embodiment of communication circuitry 1000 such as the circuitry in the base station 201 and the user equipment 211 shown in FIG. 2. The communication circuitry 1000 is alternatively grouped according to functions. Components as shown in the communication circuitry 1000 are shown here for illustrative purposes and may include other components not shown here in FIG. 10A.

The communication circuitry 1000 may include protocol processing circuitry 1005, which may implement one or more of medium access control (MAC), radio link control (RLC), packet data convergence protocol (PDCP), radio resource control (RRC) and non-access stratum (NAS) functions. The protocol processing circuitry 1005 may include one or more processing cores (not shown) to execute instructions and one or more memory structures (not shown) to store program (code) and data information.

The communication circuitry 1000 may further include digital baseband circuitry 1010, which may implement physical layer (PHY) functions including one or more of hybrid automatic repeat request (HARQ) functions, scrambling and/or descrambling, coding and/or decoding, layer mapping and/or de-mapping, modulation symbol mapping, received symbol and/or bit metric determination, multi-antenna port pre-coding and/or decoding which may include one or more of space-time, space-frequency or spatial coding, reference signal generation and/or detection, preamble sequence generation and/or decoding, synchronization sequence generation and/or detection, control channel signal blind decoding, and other related functions.

The communication circuitry 1000 may further include transmit circuitry 1015, receive circuitry 1020 and/or antenna array 1030 circuitry.

The communication circuitry 1000 may further include radio frequency (RF) circuitry 1025 such as the RF circuitry 208 and 218 in FIG. 2. In an aspect of an embodiment, RF circuitry 1025 may include multiple parallel RF chains for one or more of transmit or receive functions, each connected to one or more antennas of the antenna array 1030.

In an aspect of the disclosure, the protocol processing circuitry 1005 may include one or more instances of control circuitry (not shown) to provide control functions for one or more of digital baseband circuitry 1010, transmit circuitry 1015, receive circuitry 1020, and/or radio frequency circuitry 1025.

FIG. 10B illustrates an embodiment of radio frequency circuitry 1025 in FIG. 10A according to some aspects such as a RF circuitry 208 and 218 illustrated in FIG. 2. The radio frequency circuitry 1025 may include one or more instances of radio chain circuitry 1072, which in some aspects, may include one or more filters, power amplifiers, low noise amplifiers, programmable phase shifters and power supplies (not shown).

The radio frequency circuitry 1025 may include power combining and dividing circuitry 1074. In some aspects, power combining and dividing circuitry 1074 may operate bidirectionally, such that the same physical circuitry may be configured to operate as a power divider when the device is transmitting, and as a power combiner when the device is receiving. In some aspects, power combining and dividing circuitry 1074 may one or more include wholly or partially separate circuitries to perform power dividing when the device is transmitting and power combining when the device is receiving. In some aspects, power combining and dividing circuitry 1074 may include passive circuitry comprising one or more two-way power divider/combiners arranged in a tree. In some aspects, power combining and dividing circuitry 1074 may include active circuitry comprising amplifier circuits.

In some aspects, the radio frequency circuitry 1025 may connect to transmit circuitry 1015 and receive circuitry 1020 in FIG. 10A via one or more radio chain interfaces 1076 or a combined radio chain interface 1078. The combined radio chain interface 1078 may form a wide or very wide bandwidth.

In some aspects, one or more radio chain interfaces 1076 may provide one or more interfaces to one or more receive or transmit signals, each associated with a single antenna structure which may comprise one or more antennas.

In some aspects, the combined radio chain interface 1078 may provide a single interface to one or more receive or transmit signals, each associated with a group of antenna structures comprising one or more antennas.

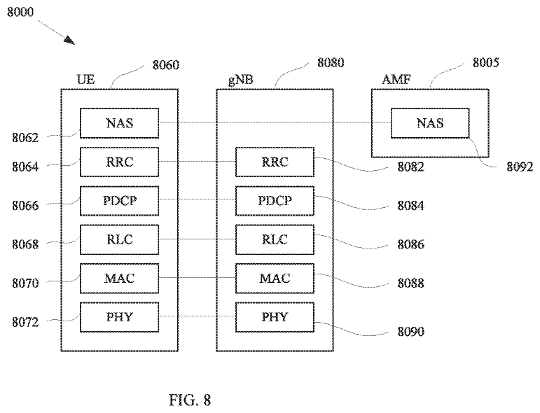

FIG. 11 illustrates an example of a storage medium 1100 to store code and data for execution by any one or more of the processors and/or processing circuitry described herein. Storage medium 1100 may comprise an article of manufacture. In some examples, storage medium 1100 may include any non-transitory computer readable medium or machine-readable medium, such as an optical, magnetic or semiconductor storage. Storage medium 1100 may store diverse types of computer executable instructions, such as instructions to implement logic flows and/or techniques described herein. Examples of a computer readable or machine-readable storage medium may include any tangible media capable of storing electronic data, including volatile memory or non-volatile memory, removable or non-removable memory, erasable or non-erasable memory, writeable or re-writeable memory, and so forth. Examples of computer executable instructions may include any suitable type of code, such as source code, compiled code, interpreted code, executable code, static code, dynamic code, object-oriented code, visual code, and the like.

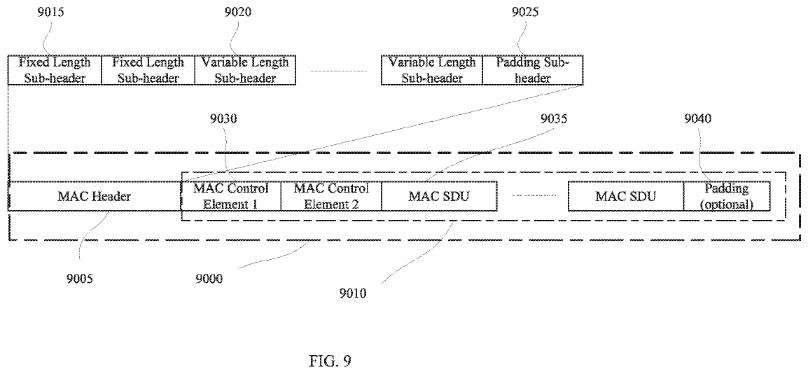

FIG. 12 illustrates an architecture of a system 1200 of a network in accordance with some embodiments. The system 1200 is shown to include a user equipment (UE) 1201 and a UE 1202 such as the UEs shown in FIGS. 1A-1C, and 2. The UEs 1201 and 1202 are illustrated as smartphones (e.g., handheld touch screen mobile computing devices connectable to one or more cellular networks) but may also comprise any mobile or non-mobile computing device, such as Personal Data Assistants (PDAs), pagers, laptop computers, desktop computers, wireless handsets, or any computing device including a wireless communications interface.

In some embodiments, any of the UEs 1201 and 1202 can comprise an Internet of Things (IoT) UE, which can comprise a network access layer designed for low-power IoT applications utilizing short-lived UE connections. An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network describes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network.

The UEs 1201 and 1202 may to connect, e.g., communicatively couple, with a radio access network (RAN)-in this embodiment, an Evolved Universal Mobile Telecommunications System (UMTS) Terrestrial Radio Access Network (E-UTRAN) 1210 such as the base stations shown in FIGS. 1A-1B, and 2. The UEs 1201 and 1202 utilize connections 1203 and 1204, respectively, each of which comprises a physical communications interface or layer (discussed in further detail below); in this example, the connections 1203 and 1204 are illustrated as an air interface to enable communicative coupling, and can be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a fifth generation (5G) protocol, a New Radio (NR) protocol, and the like.

In this embodiment, the UEs 1201 and 1202 may further directly exchange communication data via a ProSe interface 1205. The ProSe interface 1205 may alternatively be referred to as a sidelink interface comprising one or more logical channels, including but not limited to a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH).

The UE 1202 is shown to be configured to access an access point (AP) 1206 via connection 1207. The connection 1207 can comprise a local wireless connection, such as a connection consistent with any IEEE 802.11 protocol, wherein the AP 1206 would comprise a wireless fidelity (WiFi®) router. In this example, the AP 1206 is shown to be connected to the Internet without connecting to the core network of the wireless system (described in further detail below). The E-UTRAN 1210 can include one or more access nodes that enable the connections 1203 and 1204. These access nodes (ANs) can be referred to as base stations (BSs), NodeBs, evolved NodeBs (eNBs), next Generation NodeBs (gNB), RAN nodes, and so forth, and can comprise ground stations (e.g., terrestrial access points) or satellite stations providing coverage within a geographic area (e.g., a cell). The E-UTRAN 1210 may include one or more RAN nodes for providing macro-cells, e.g., macro RAN node 1211, and one or more RAN nodes for providing femto-cells or picocells (e.g., cells having smaller coverage areas, smaller user capacity, or higher bandwidth compared to macro-cells), e.g., low power (LP) RAN node 1212.

Any of the RAN nodes 1211 and 1212 can terminate the air interface protocol and can be the first point of contact for the UEs 1201 and 1202. In some embodiments, any of the RAN nodes 1211 and 1212 can fulfill various logical functions for the E-UTRAN 1210 including, but not limited to, radio network controller (RNC) functions such as radio bearer management, uplink and downlink dynamic radio resource management and data packet scheduling, and mobility management.

In accordance with some embodiments, the UEs 1201 and 1202 can be configured to communicate using Orthogonal Frequency-Division Multiplexing (OFDM) communication signals with each other or with any of the RAN nodes 1211 and 1212 over a multicarrier communication channel in accordance various communication techniques, such as, but not limited to, an Orthogonal Frequency-Division Multiple Access (OFDMA) communication technique (e.g., for downlink communications) or a Single Carrier Frequency Division Multiple Access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, a downlink resource grid can be used for downlink transmissions from any of the RAN nodes 1211 and 1212 to the UEs 1201 and 1202, while uplink transmissions can utilize similar techniques. The grid can be a time-frequency grid, called a resource grid or time-frequency resource grid, which is the physical resource in the downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises a number of resource blocks, which describe the mapping of certain physical channels to resource elements. Each resource block comprises a collection of resource elements; in the frequency domain, this may represent the smallest quantity of resources that currently can be allocated. There are several different physical downlink (DL) channels that are conveyed using such resource blocks.

The physical downlink shared channel (PDSCH) may carry user data and higher-layer signaling to the UEs 1201 and 1202. The physical downlink control channel (PDCCH) may carry information about the transport format and resource allocations related to the PDSCH channel, among other things. It may also inform the UEs 1201 and 1202 about the transport format, resource allocation, and HARQ (Hybrid Automatic Repeat Request) information related to the uplink shared channel. Typically, downlink scheduling (assigning control and shared channel resource blocks to the UE 102 within a cell) may be performed at any of the RAN nodes 1211 and 1212 based on channel quality information fed back from any of the UEs 1201 and 1202. The downlink resource assignment information may be sent on the PDCCH used for (e.g., assigned to) each of the UEs 1201 and 1202.

The PDCCH may use control channel elements (CCEs) to convey the control information. Before being mapped to resource elements, the PDCCH complex-valued symbols may first be organized into quadruplets, which may then be permuted using a sub-block interleaver for rate matching. Each PDCCH may be transmitted using one or more of these CCEs, where each CCE may correspond to nine sets of four physical resource elements known as resource element groups (REGs). Four Quadrature Phase Shift Keying (QPSK) symbols may be mapped to each REG. The PDCCH can be transmitted using one or more CCEs, depending on the size of the downlink control information (DCI) and the channel condition. There can be four or more different PDCCH formats defined in LTE with different numbers of CCEs (e.g., aggregation level, L=1, 2, 4, or 8).

Some embodiments may use concepts for resource allocation for control channel information that are an extension of the above-described concepts. For example, some embodiments may utilize an enhanced physical downlink control channel (EPDCCH) that uses PDSCH resources for control information transmission. The EPDCCH may be transmitted using one or more enhanced the control channel elements (ECCEs). Similar to above, each ECCE may correspond to nine sets of four physical resource elements known as an enhanced resource element groups (EREGs). An ECCE may have other numbers of EREGs in some situations.

The RAN nodes 1211 and 1212 may communicate with one another and/or with other access nodes in the E-UTRAN 1210 and/or in another RAN via an X2 interface, which is a signaling interface for communicating data packets between ANs. Some other suitable interface for communicating data packets directly between ANs may be used.

The E-UTRAN 1210 is shown to be communicatively coupled to a core network—in this embodiment, an Evolved Packet Core (EPC) network 1220 via an SI interface 1213. In this embodiment the SI interface 1213 is split into two parts: the SI-U interface 1214, which carries traffic data between the RAN nodes 1211 and 1212 and the serving gateway (S-GW) 1222, and the SI-mobility management entity (MME) interface 1215, which is a signaling interface between the RAN nodes 1211 and 1212 and MMEs 1221.

In this embodiment, the EPC network 1220 comprises the MMEs 1221, the S-GW 1222, the Packet Data Network (PDN) Gateway (P-GW) 1223, and a home subscriber server (HSS) 1224. The MMEs 1221 may be similar in function to the control plane of legacy Serving General Packet Radio Service (GPRS) Support Nodes (SGSN). The MMEs 1221 may manage mobility aspects in access such as gateway selection and tracking area list management. The HSS 1224 may comprise a database for network users, including subscription-related information to support the network entities' handling of communication sessions. The EPC network 1220 may comprise one or several HSSs 1224, depending on the number of mobile subscribers, on the capacity of the equipment, on the organization of the network, etc. For example, the HSS 1224 can provide support for routing/roaming, authentication, authorization, naming/addressing resolution, location dependencies, etc.

The S-GW 1222 may terminate the SI interface 1213 towards the E-UTRAN 1210, and routes data packets between the E-UTRAN 1210 and the EPC network 1220. In addition, the S-GW 1222 may be a local mobility anchor point for inter-RAN node handovers and also may provide an anchor for inter-3GPP mobility. Other responsibilities may include lawful intercept, charging, and some policy enforcement.

The P-GW 1223 may terminate an SGi interface toward a PDN. The P-GW 1223 may route data packets between the EPC network 1220 and external networks such as a network including the application server 1230 (alternatively referred to as application function (AF)) via an Internet Protocol (IP) interface 1225. Generally, the application server 1230 may be an element offering applications that use IP bearer resources with the core network (e.g., UMTS Packet Services (PS) domain, LTE PS data services, etc.). In this embodiment, the P-GW 1223 is shown to be communicatively coupled to an application server 1230 via an IP interface 1225. The application server 1230 can also be configured to support one or more communication services (e.g., Voice-over-Internet Protocol (VOIP) sessions, PTT sessions, group communication sessions, social networking services, etc.) for the UEs 1201 and 1202 via the EPC network 1220.

The P-GW 1223 may further be a node for policy enforcement and charging data collection. Policy and Charging Enforcement Function (PCRF) 1226 is the policy and charging control element of the EPC network 1220. In a non-roaming scenario, there may be a single PCRF in the Home Public Land Mobile Network (HPLMN) associated with a UE's Internet Protocol Connectivity Access Network (IP-CAN) session. In a roaming scenario with local breakout of traffic, there may be two PCRFs associated with a UE's IP-CAN session: a Home PCRF (H-PCRF) within a HPLMN and a Visited PCRF (V-PCRF) within a Visited Public Land Mobile Network (VPLMN). The PCRF 1226 may be communicatively coupled to the application server 1230 via the P-GW 1223. The application server 1230 may signal the PCRF 1226 to indicate a new service flow and select the appropriate Quality of Service (QoS) and charging parameters. The PCRF 1226 may provision this rule into a Policy and Charging Enforcement Function (PCEF) (not shown) with the appropriate traffic flow template (TFT) and QoS class of identifier (QCI), which commences the QoS and charging as specified by the application server 1230.

FIG. 13 illustrates example components of a device 1300 in accordance with some embodiments such as the base stations and UEs shown and/or discussed in conjunction with FIGS. 1-12. In some embodiments, the device 1300 may include application circuitry 1302, baseband circuitry 1304, Radio Frequency (RF) circuitry 1306, front-end module (FEM) circuitry 1308, one or more antennas 1310, and power management circuitry (PMC) 1312 coupled together at least as shown. The components of the illustrated device 1300 may be included in a UE or a RAN node such as a base station or gNB. In some embodiments, the device 1300 may include less elements (e.g., a RAN node may not utilize application circuitry 1302, and instead include a processor/controller to process IP data received from an EPC). In some embodiments, the device 1300 may include additional elements such as, for example, memory/storage, display, camera, sensor, or input/output (I/O) interface. In other embodiments, the components described below may be included in more than one device (e.g., said circuitries may be separately included in more than one device for Cloud-RAN (C-RAN) implementations).

The application circuitry 1302 may include one or more application processors. For example, the application circuitry 1302 may include circuitry such as, but not limited to, one or more single-core or multi-core processors. The processor(s) may include any combination of general-purpose processors and dedicated processors (e.g., graphics processors, application processors, etc.). The processors may be coupled with or may include memory/storage and may be configured to execute instructions stored in the memory/storage to enable various applications or operating systems to run on the device 1300. In some embodiments, processors of application circuitry 1302 may process IP data packets received from an EPC.

The baseband circuitry 1304 may include circuitry such as, but not limited to, one or more single-core or multi-core processors. The baseband circuitry 1304 may include one or more baseband processors or control logic to process baseband signals received from a receive signal path of the RF circuitry 1306 and to generate baseband signals for a transmit signal path of the RF circuitry 1306. The baseband circuitry 1304 may interface with the application circuitry 1302 for generation and processing of the baseband signals and for controlling operations of the RF circuitry 1306. For example, in some embodiments, the baseband circuitry 1304 may include a third generation (3G) baseband processor 1304A, a fourth generation (4G) baseband processor 1304B, a fifth generation (5G) baseband processor 1304C, or other baseband processor(s) 1304D for other existing generations, generations in development or to be developed in the future (e.g., second generation (2G), sixth generation (6G), etc.). In many embodiments, the fourth generation (4G) baseband processor 1304B may include capabilities for generation and processing of the baseband signals for LTE radios and the fifth generation (5G) baseband processor 1304C may capabilities for generation and processing of the baseband signals for NRs.

The baseband circuitry 1304 (e.g., one or more of baseband processors 1304A-D) may handle various radio control functions that enable communication with one or more radio networks via the RF circuitry 1306. In other embodiments, some of or all the functionality of baseband processors 1304A-D may be included in modules stored in the memory 1304G and executed via a Central Processing Unit (CPU) 1304E. The radio control functions may include, but are not limited to, signal modulation/demodulation, encoding/decoding, radio frequency shifting, etc.

In some embodiments, modulation/demodulation circuitry of the baseband circuitry 1304 may include Fast-Fourier Transform (FFT), precoding, or constellation mapping/demapping functionality. In some embodiments, encoding/decoding circuitry of the baseband circuitry 1304 may include convolution, tail-biting convolution, turbo, Viterbi, or Low-Density Parity Check (LDPC) encoder/decoder functionality. Embodiments of modulation/demodulation and encoder/decoder functionality are not limited to these examples and may include other suitable functionality in other embodiments.

In some embodiments, the baseband circuitry 1304 may include one or more audio digital signal processor(s) (DSP) 1304F. The audio DSP(s) 1304F may be include elements for compression/decompression and echo cancellation and may include other suitable processing elements in other embodiments. Components of the baseband circuitry may be suitably combined in a single chip, a single chipset, or disposed on a same circuit board in some embodiments. In some embodiments, some of or all the constituent components of the baseband circuitry 1304 and the application circuitry 1302 may be implemented together such as, for example, on a system on a chip (SOC). In some embodiments, the baseband circuitry 1304 may provide for communication compatible with one or more radio technologies. For example, in some embodiments, the baseband circuitry 1304 may support communication with an evolved universal terrestrial radio access network (E-UTRAN) or other wireless metropolitan area networks (WMAN), a wireless local area network (WLAN), a wireless personal area network (WPAN). Embodiments in which the baseband circuitry 1304 is configured to support radio communications of more than one wireless protocol may be referred to as multi-mode baseband circuitry.

The RF circuitry 1306 may enable communication with wireless networks using modulated electromagnetic radiation through a non-solid medium. In various embodiments, the RF circuitry 1306 may include switches, filters, amplifiers, etc. to facilitate the communication with the wireless network. The RF circuitry 1306 may include a receive signal path which may include circuitry to down-convert RF signals received from the FEM circuitry 1308 and provide baseband signals to the baseband circuitry 1304. The RF circuitry 1306 may also include a transmit signal path which may include circuitry to up-convert baseband signals provided by the baseband circuitry 1304 and provide RF output signals to the FEM circuitry 1308 for transmission.

In some embodiments, the receive signal path of the RF circuitry 1306 may include mixer circuitry 1306a, amplifier circuitry 1306b and filter circuitry 1306c. In some embodiments, the transmit signal path of the RF circuitry 1306 may include filter circuitry 1306c and mixer circuitry 1306a. The RF circuitry 1306 may also include synthesizer circuitry 1306d for synthesizing a frequency, or component carrier, for use by the mixer circuitry 1306a of the receive signal path and the transmit signal path. In some embodiments, the mixer circuitry 1306a of the receive signal path may to down-convert RF signals received from the FEM circuitry 1308 based on the synthesized frequency provided by synthesizer circuitry 1306d. The amplifier circuitry 1306b may amplify the down-converted signals and the filter circuitry 1306c may be a low-pass filter (LPF) or band-pass filter (BPF) to remove unwanted signals from the down-converted signals to generate output baseband signals. Output baseband signals may be provided to the baseband circuitry 1304 for further processing.

In some embodiments, the output baseband signals may be zero-frequency baseband signals, although this is not a requirement. In some embodiments, mixer circuitry 1306a of the receive signal path may comprise passive mixers, although the scope of the embodiments is not limited in this respect.

In some embodiments, the mixer circuitry 1306a of the transmit signal path may be configured to up-convert input baseband signals based on the synthesized frequency provided by the synthesizer circuitry 1306d to generate RF output signals for the FEM circuitry 1308. The baseband signals may be provided by the baseband circuitry 1304 and may be filtered by filter circuitry 1306c.

In some embodiments, the mixer circuitry 1306a of the receive signal path and the mixer circuitry 1306a of the transmit signal path may include two or more mixers and may be arranged for quadrature downconversion and upconversion, respectively. In some embodiments, the mixer circuitry 1306a of the receive signal path and the mixer circuitry 1306a of the transmit signal path may include two or more mixers and may be arranged for image rejection (e.g., Hartley image rejection). In some embodiments, the mixer circuitry 1306a of the receive signal path and the mixer circuitry 1306a may be arranged for direct downconversion and direct upconversion, respectively. In some embodiments, the mixer circuitry 1306a of the receive signal path and the mixer circuitry 1306a of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry 1306 may include analog-to-digital converter (ADC) and digital-to-analog converter (DAC) circuitry and the baseband circuitry 1304 may include a digital baseband interface to communicate with the RF circuitry 1306.

In some dual-mode embodiments, a separate radio IC circuitry may be provided for processing signals for each spectrum, although the scope of the embodiments is not limited in this respect.

In some embodiments, the synthesizer circuitry 1306d may be a fractional-N synthesizer or a fractional NIN+I synthesizer, although the scope of the embodiments is not limited in this respect as other types of frequency synthesizers may be suitable. For example, synthesizer circuitry 1306d may be a delta-sigma synthesizer, a frequency multiplier, or a synthesizer comprising a phase-locked loop with a frequency divider.

The synthesizer circuitry 1306d may synthesize an output frequency for use by the mixer circuitry 1306a of the RF circuitry 1306 based on a frequency input and a divider control input. In some embodiments, the synthesizer circuitry 1306d may be a fractional NIN+I synthesizer.

In some embodiments, frequency input may be an output of a voltage-controlled oscillator (VCO), although that is not a requirement. Divider control input may be an output of either the baseband circuitry 1304 or an application processor of the applications circuitry 1302 depending on the desired output frequency. Some embodiments may determine a divider control input (e.g., N) from a look-up table based on a channel indicated by the applications circuitry 1302.

The synthesizer circuitry 1306d of the RF circuitry 1306 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may break a VCO period up into Nd equal packets of phase, where Nd is the number of delay elements in the delay line. In this way, the DLL provides negative feedback to help ensure that the total delay through the delay line is one VCO cycle.

In some embodiments, the synthesizer circuitry 1306d may generate a carrier frequency (or component carrier) as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a local oscillator (LO) frequency (fLO). In some embodiments, the RF circuitry 1306 may include an IQ/polar converter.

The FEM circuitry 1308 may include a receive signal path which may include circuitry to operate on RF signals received from one or more antennas 1310, amplify the received signals and provide the amplified versions of the received signals to the RF circuitry 1306 for further processing. FEM circuitry 1308 may also include a transmit signal path which may include circuitry configured to amplify signals for transmission provided by the RF circuitry 1306 for transmission by one or more of the one or more antennas 1310. In various embodiments, the amplification through the transmit or receive signal paths may be done solely in the RF circuitry 1306, solely in the FEM circuitry 1308, or in both the RF circuitry 1306 and the FEM circuitry 1308.

In some embodiments, the FEM circuitry 1308 may include a TX/RX switch to switch between transmit mode and receive mode operation. The FEM circuitry may include a receive signal path and a transmit signal path. The receive signal path of the FEM circuitry may include a low-noise amplifier (LNA) to amplify received RF signals and provide the amplified received RF signals as an output (e.g., to the RF circuitry 1306). The transmit signal path of the FEM circuitry 1308 may include a power amplifier (PA) to amplify input RF signals (e.g., provided by RF circuitry 1306), and one or more filters to generate RF signals for subsequent transmission (e.g., by one or more of the one or more antennas 1310).

In the present embodiment, the radio refers to a combination of the RF circuitry 130 and the FEM circuitry 1308. The radio refers to the portion of the circuitry that generates and transmits or receives and processes the radio signals. The RF circuitry 1306 includes a transmitter to generate the time domain radio signals with the data from the baseband signals and apply the radio signals to subcarriers of the carrier frequency that form the bandwidth of the channel. The PA in the FEM circuitry 1308 amplifies the tones for transmission and amplifies tones received from the one or more antennas 1310 via the LNA to increase the signal-to-noise ratio (SNR) for interpretation. In wireless communications, the FEM circuitry 1308 may also search for a detectable pattern that appears to be a wireless communication. Thereafter, a receiver in the RF circuitry 1306 converts the time domain radio signals to baseband signals via one or more functional modules such as the functional modules shown in the base station 201 and the user equipment 211 illustrated in FIG. 2.

In some embodiments, the PMC 1312 may manage power provided to the baseband circuitry 1304. In particular, the PMC 1312 may control power-source selection, voltage scaling, battery charging, or DC-to-DC conversion. The PMC 1312 may often be included when the device 1300 is capable of being powered by a battery, for example, when the device is included in a UE. The PMC 1312 may increase the power conversion efficiency while providing desirable implementation size and heat dissipation characteristics.

While FIG. 13 shows the PMC 1312 coupled only with the baseband circuitry 1304. However, in other embodiments, the PMC 1312 may be additionally or alternatively coupled with, and perform similar power management operations for, other components such as, but not limited to, application circuitry 1302, RF circuitry 1306, or FEM circuitry 1308.

In some embodiments, the PMC 1312 may control, or otherwise be part of, various power saving mechanisms of the device 1300. For example, if the device 1300 is in an RRC_Connected state, where it is still connected to the RAN node as it expects to receive traffic shortly, then it may enter a state known as Discontinuous Reception Mode (DRX) after a period of inactivity. During this state, the device 1300 may power down for brief intervals of time and thus save power.

If there is no data traffic activity for an extended period of time, then the device 1300 may transition off to an RRC Idle state, where it disconnects from the network and does not perform operations such as channel quality feedback, handover, etc. The device 1300 goes into a very low power state and it performs paging where again it periodically wakes up to listen to the network and then powers down again. The device 1300 may not receive data in this state, in order to receive data, it must transition back to RRC_Connected state.

An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

The processors of the application circuitry 1302 and the processors of the baseband circuitry 1304 may be used to execute elements of one or more instances of a protocol stack. For example, processors of the baseband circuitry 1304, alone or in combination, may be used execute Layer 3, Layer 2, or Layer 1 functionality, while processors of the application circuitry 1302 may utilize data (e.g., packet data) received from these layers and further execute Layer 4 functionality (e.g., transmission communication protocol (TCP) and user datagram protocol (UDP) layers). As referred to herein, Layer 3 may comprise a radio resource control (RRC) layer, described in further detail below. As referred to herein, Layer 2 may comprise a medium access control (MAC) layer, a radio link control (RLC) layer, and a packet data convergence protocol (PDCP) layer, described in further detail below. As referred to herein, Layer 1 may comprise a physical (PHY) layer of a UE/RAN node, described in further detail below.

FIG. 14 illustrates example interfaces of baseband circuitry in accordance with some embodiments such as the baseband circuitry shown in FIGS. 1A-1C, 2, and 13. As discussed above, the baseband circuitry 1304 of FIG. 13 may comprise processors 1304A-1304E and a memory 1304G utilized by said processors. Each of the processors 1304A-1304E may include a memory interface, 1404A-1404E, respectively, to send/receive data to/from the memory 1304G.

The baseband circuitry 1304 may further include one or more interfaces to communicatively couple to other circuitries/devices, such as a memory interface 1412 (e.g., an interface to send/receive data to/from memory external to the baseband circuitry 1304), an application circuitry interface 1414 (e.g., an interface to send/receive data to/from the application circuitry 1302 of FIG. 13), an RF circuitry interface 1416 (e.g., an interface to send/receive data to/from RF circuitry 1306 of FIG. 13), a wireless hardware connectivity interface 1418 (e.g., an interface to send/receive data to/from Near Field Communication (NFC) components, Bluetooth® components (e.g., Bluetooth® Low Energy), Wi-Fi® components, and other communication components), and a power management interface 1420 (e.g., an interface to send/receive power or control signals to/from the PMC 1312.

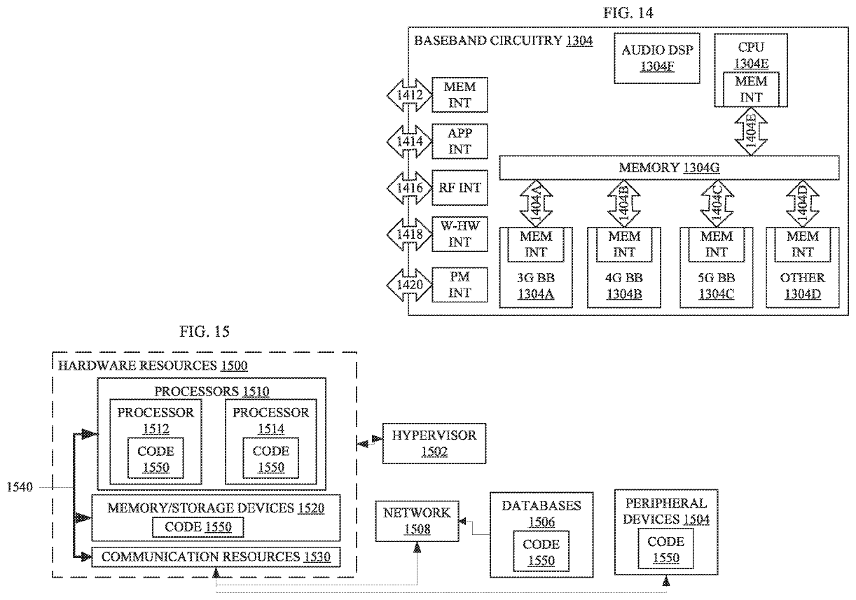

FIG. 15 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 15 shows a diagrammatic representation of hardware resources 1500 including one or more processors (or processor cores) 1510, one or more memory/storage devices 1520, and one or more communication resources 1530, each of which may be communicatively coupled via a bus 1540. For embodiments where node virtualization (e.g., NFV) is utilized, a hypervisor 1502 may be executed to provide an execution environment for one or more network slices/sub-slices to utilize the hardware resources 1500.

The processors 1510 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) may include, for example, a processor 1512 and a processor 1514.

The memory/storage devices 1520 may include main memory, disk storage, or any suitable combination thereof. The memory/storage devices 1520 may include, but are not limited to any type of volatile or non-volatile memory such as dynamic random-access memory (DRAM), static random-access memory (SRAM), erasable programmable read-only memory (EPROM), electrically erasable programmable read-only memory (EEPROM), Flash memory, solid-state storage, etc.

The communication resources 1530 may include interconnection or network interface components or other suitable devices to communicate with one or more peripheral devices 1504 or one or more databases 1506 via a network 1508. For example, the communication resources 1530 may include wired communication components (e.g., for coupling via a Universal Serial Bus (USB)), cellular communication components, NFC components, Bluetooth® components (e.g., Bluetooth® Low Energy), Wi-Fi® components, and other communication components.

Instructions 1550 may comprise software, a program, an application, an applet, an app, or other executable code for causing at least any of the processors 1510 to perform any one or more of the methodologies discussed herein. The instructions 1550 may reside, completely or partially, within at least one of the processors 1510 (e.g., within the processor's cache memory), the memory/storage devices 1520, or any suitable combination thereof. Furthermore, any portion of the instructions 1550 may be transferred to the hardware resources 1500 from any combination of the peripheral devices 1504 or the databases 1506. Accordingly, the memory of processors 1510, the memory/storage devices 1520, the peripheral devices 1504, and the databases 1506 are examples of computer-readable and machine-readable media.

In embodiments, one or more elements of FIGS. 12, 13, 14, and/or 15 may be configured to perform one or more processes, techniques, or methods as described herein, or portions thereof. In embodiments, one or more elements of FIGS. 12, 13, 14, and/or 15 may be configured to perform one or more processes, techniques, or methods, or portions thereof, as described in the following examples.

As used herein, the term “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some examples may be described using the expression “in one example” or “an example” along with their derivatives. These terms mean that a particular feature, structure, or characteristic described in connection with the example is included in at least one example. The appearances of the phrase “in one example” in various places in the specification are not necessarily all referring to the same example.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

In addition, in the foregoing Detailed Description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code to reduce the number of times code must be retrieved from bulk storage during execution. The term “code” covers a broad range of software components and constructs, including applications, drivers, processes, routines, methods, modules, firmware, microcode, and subprograms. Thus, the term “code” may be used to refer to any collection of instructions which, when executed by a processing system, perform a desired operation or operations.

Processing circuitry, logic circuitry, devices, and interfaces herein described may perform functions implemented in hardware and also implemented with code executed on one or more processors. Processing circuitry, or logic circuitry, refers to the hardware or the hardware and code that implements one or more logical functions. Circuitry is hardware and may refer to one or more circuits. Each circuit may perform a particular function. A circuit of the circuitry may comprise discrete electrical components interconnected with one or more conductors, an integrated circuit, a chip package, a chip set, memory, or the like. Integrated circuits include circuits created on a substrate such as a silicon wafer and may comprise components. And integrated circuits, processor packages, chip packages, and chipsets may comprise one or more processors.

Processors may receive signals such as instructions and/or data at the input(s) and process the signals to generate the at least one output. While executing code, the code changes the physical states and characteristics of transistors that make up a processor pipeline. The physical states of the transistors translate into logical bits of ones and zeros stored in registers within the processor. The processor can transfer the physical states of the transistors into registers and transfer the physical states of the transistors to another storage medium.

A processor may comprise circuits or circuitry to perform one or more sub-functions implemented to perform the overall function of “a processor”. Note that “a processor” may comprise one or more processors and each processor may comprise one or more processor cores that independently or interdependently process code and/or data. Each of the processor cores are also “processors” and are only distinguishable from processors for the purpose of describing a physical arrangement or architecture of a processor with multiple processor cores on one or more dies and/or within one or more chip packages. Processor cores may comprise general processing cores or may comprise processor cores configured to perform specific tasks, depending on the design of the processor. Processor cores may be processors with one or more processor cores. As discussed and claimed herein, when discussing functionality performed by a processor, processing circuitry, or the like; the processor, processing circuitry, or the like may comprise one or more processors, each processor having one or more processor cores, and any one or more of the processors and/or processor cores may reside on one or more dies, within one or more chip packages, and may perform part of or all the processing required to perform the functionality.

One example of a processor is a state machine or an application-specific integrated circuit (ASIC) that includes at least one input and at least one output. A state machine may manipulate the at least one input to generate the at least one output by performing a predetermined series of serial and/or parallel manipulations or transformations on the at least one input.

Several embodiments have one or more potentially advantages effects. For instance, user equipment (UE) to allocate sidelink (SL) resources for sidelink communications may advantageously perform resource selection from at least one resource pool to determine a set of resources from the at least one resource pool for transmission of a reference signal. User equipment (UE) to allocate sidelink (SL) resources for sidelink communications may advantageously autonomously allocate the set of resources for a transmission of the reference signal within in a physical sidelink shared channel (PSSCH) or as a standalone transmission. User equipment (UE) to allocate sidelink (SL) resources for sidelink communications may advantageously generate a control information signal to signal the set of resources for the reference signal, wherein the control information signal comprises a source identifier field, a destination identifier field, and one or more fields to indicate automatic gain control, guard symbols, or a combination thereof. User equipment (UE) to allocate sidelink (SL) resources for sidelink communications may advantageously encoding the control information signal for transmission to a second UE. User equipment (UE) to allocate sidelink (SL) resources for sidelink communications may advantageously generate the reference signal for a unicast, broadcast, or groupcast transmission. User equipment (UE) to allocate sidelink (SL) resources for sidelink communications may advantageously encode the reference signal for transmission via the set of resources within the PSSCH. User equipment (UE) to allocate sidelink (SL) resources for sidelink communications may advantageously select of periodic or aperiodic resources for the SL PRS. User equipment (UE) to allocate sidelink (SL) resources for sidelink communications may advantageously comprise full sensing-based resource selection, partial sensing-based resource selection, or random resource selection. User equipment (UE) to allocate sidelink (SL) resources for sidelink communications may advantageously reserve the set of resources with a set of one or more coordinating UEs, wherein the one or more coordinating UEs resolve reservation conflicts. User equipment (UE) to allocate sidelink (SL) resources for sidelink communications may advantageously monitor communications for the CLI. User equipment (UE) to allocate sidelink (SL) resources for sidelink communications advantageously determine a resource selection window (RSW) to limit reservation of resources to a window of time for round trip time (RTT) based ranging.

### EXAMPLES OF FURTHER EMBODIMENTS

The following examples pertain to further embodiments. Specifics in the examples may be used anywhere in one or more embodiments.

Example 1 is an apparatus for user equipment (UE) to allocate sidelink (SL) resources for sidelink communications, comprising an interface for wireless communication; and processing circuitry coupled with the interface to perform resource selection from a resource pool to determine a set of resources from the resource pool for transmission of a reference signal in a physical sidelink shared channel (PSSCH); autonomously allocate the set of resources for a transmission of the reference signal within the PSSCH or as a standalone reference signal transmission; generate a control information signal to signal the set of resources for the reference signal, the control information signal comprising a source identifier field, a destination identifier field, and one or more fields to indicate automatic gain control, guard symbols, or a combination thereof; and encode the control information signal for transmission to a second UE via the interface. In Example 2, the apparatus of Example 1, wherein the processing circuitry comprises a processor and a memory coupled with the processor, a radio frequency circuitry coupled with the processor, and one or more antennas coupled with the radio frequency circuitry. In Example 3, the apparatus of Example 1, the processing circuitry to further generate the reference signal for a unicast, broadcast, or groupcast transmission; and encode the reference signal for transmission via the set of resources within the PSSCH. In Example 4, the apparatus of Example 3, wherein the reference signal comprises a sidelink positioning reference signal (SL PRS), a demodulation reference signal (DMRS), or a channel state information reference signal (CSI-RS) and the control information signal comprises a field to indicate a presence of the SL PRS, DMRS, or CSI-RS, respectively. In Example 5, the apparatus of Example 1, wherein performance of the resource selection comprises selection of periodic or aperiodic resources for the SL PRS. In Example 6, the apparatus of Example 1, wherein performance of the resource selection comprises full sensing-based resource selection, partial sensing-based resource selection, or random resource selection. In Example 7, the apparatus of Example 1, wherein autonomous allocation comprises reserving the set of resources with a set of one or more coordinating UEs, wherein the one or more coordinating UEs resolve reservation conflicts. In Example 8, the apparatus of Example 1, wherein the control information signal comprises a first stage sidelink control information (SCI) format 1-B for transmission via a physical sidelink control channel (PSCCH), a Medium Access Control-Control Element (MAC-CE) based signaling, or a radio resource control layer signaling. In Example 9, the apparatus of Example 1, wherein the control information signal comprises the first stage sidelink control information (SCI) format 1-B or a 2^{nd} stage SCI format 2-D, wherein the first stage SCI format 1-B comprises a source identifier field, a destination identifier field, a resource reservation period, a SL PRS priority field and a cast type field, and one or more additional fields comprising a SL PRS presence field, a demodulation reference signal (DMRS) presence field for positioning-based measurements, a channel state information reference signal (CSI-RS) presence field, or a combination thereof. In Example 10, the apparatus of any Example 1-9, the processing circuitry to determine a resource selection window (RSW) to limit reservation of resources to a window of time for round trip time (RTT) based ranging.

Example 11 is a method for user equipment (UE) to allocate sidelink (SL) resources for sidelink communications, comprising performing resource selection from at least one resource pool to determine a set of resources from the at least one resource pool for transmission of a reference signal in a physical sidelink shared channel (PSSCH); autonomously allocating the set of resources for a transmission of the reference signal within the PSSCH or as a standalone reference signal transmission; generating a control information signal to signal the set of resources for the reference signal, wherein the control information signal comprises a source identifier field, a destination identifier field, and one or more fields to indicate automatic gain control, guard symbols, or a combination thereof; and encoding the control information signal for transmission to a second UE. In Example 12, the method of Example 11, further comprising generating the reference signal for a unicast, broadcast, or groupcast transmission; and encoding the reference signal for transmission via the set of resources within the PSSCH. In Example 13, the method of Example 12, wherein the reference signal comprises a sidelink positioning reference signal (SL PRS), a demodulation reference signal (DMRS), or a channel state information reference signal (CSI-RS) and the control information signal comprises a field to indicate a presence of the SL PRS, DMRS, or CSI-RS, respectively. In Example 14, the method of any one of Examples 11-13, wherein performance of the resource selection comprises selection of periodic or aperiodic resources for the SL PRS.

Example 15 is a machine-readable medium containing instructions for user equipment (UE) to allocate sidelink (SL) resources for sidelink communications, which when executed by a processor, cause the processor to perform operations, the operations to perform resource selection from at least one resource pool to determine a set of resources from the at least one resource pool for transmission of a reference signal in a physical sidelink shared channel (PSSCH); autonomously allocate the set of resources for a transmission of the reference signal within the PSSCH or as a standalone reference signal transmission; generate a control information signal to signal the set of resources for the reference signal, wherein the control information signal comprises a source identifier field, a destination identifier field, and one or more fields to indicate automatic gain control, guard symbols, or a combination thereof; and encode the control information signal for transmission to a second UE. In Example 16, the machine-readable medium of Example 12, wherein performance of the resource selection comprises full sensing-based resource selection, partial sensing-based resource selection, or random resource selection. In Example 17, the machine-readable medium of Example 12, wherein autonomous allocation comprises reserving the set of resources with a set of one or more coordinating UEs, wherein the one or more coordinating UEs resolve reservation conflicts. In Example 18, the machine-readable medium of any of Examples 12-17, wherein the control information signal comprises a first stage sidelink control information (SCI) format 1-B for transmission via a physical sidelink control channel (PSCCH), a Medium Access Control-Control Element (MAC-CE) based signaling, or a radio resource control layer signaling.

Example 19 is an apparatus of a base station for sidelink (SL) positioning, comprising an interface for wireless communication; and processing circuitry coupled with the interface to decode a control information signal to determine the set of resources for the reference signal, the control information signal comprising a source identifier field, a destination identifier field, and one or more fields to indicate automatic gain control, guard symbols, or a combination thereof; decode a reference signal in a physical sidelink shared channel (PSSCH), or as a standalone reference signal transmission, based on values in one or more fields in the control information signal; and encode a response to receipt of the reference signal with positioning information for transmission via the interface. In Example 20, the apparatus of Example 19, wherein the processing circuitry comprises a processor and a memory coupled with the processor, a radio frequency circuitry coupled with the processing circuitry, and one or more antennas coupled with the radio frequency circuitry. In Example 21, the apparatus of any Example 19-20, the processing circuitry to further decode a communication comprises remaining information to facilitate ranging.

Example 22 is a method of a base station for sidelink (SL) positioning, comprising decoding a control information signal to determine the set of resources for the reference signal, the control information signal comprising a source identifier field, a destination identifier field, and one or more fields to indicate automatic gain control, guard symbols, or a combination thereof; decoding a reference signal in a physical sidelink shared channel (PSSCH), or as a standalone reference signal transmission, based on values in one or more fields in the control information signal; and encoding a response to receipt of the reference signal with positioning information. In Example 23, the method of Example 20, further comprising determining a resource selection window (RSW) to limit reservation of resources to a window of time for round trip time (RTT) based ranging.

Example 24 is a machine-readable medium containing instructions for sidelink (SL) positioning, which when executed by a processor, cause the processor to perform operations to report a cross link interference, the operations to decode a control information signal to determine the set of resources for the reference signal, the control information signal comprising a source identifier field, a destination identifier field, and one or more fields to indicate automatic gain control, guard symbols, or a combination thereof; decode a reference signal in a physical sidelink shared channel (PSSCH), or as a standalone reference signal transmission, based on values in one or more fields in the control information signal; and encode a response to receipt of the reference signal with positioning information. In Example 25, the machine-readable medium of Example 24, the operations to further perform a negotiation with a transmitting UE to agree on the roles of the initiating and responding UEs; and perform resource selection from a resource pool to allocate a set of resources for a RSW for a subsequent transmission by the transmitting UE of a subsequent reference signal.

Example 26 is an apparatus comprising a means for any Example 11-14.

Example 27 is an apparatus comprising a means for any Example 22-23.

1-40. (canceled)

41. An apparatus for user equipment (UE) to allocate sidelink (SL) resources for sidelink communications, comprising:
an interface for wireless communication; and
processing circuitry coupled with the interface to:
generate a SL control information to signal a set of resources for scheduling a reference signal, the SL control information comprising a source identifier field, a destination identifier field, a cast-type indicator field, and a resource reservation period;
encode the SL control information for transmission to a second UE via the interface; and
cause transmission of the SL control information to allocate the set of resources for the reference signal within a physical sidelink shared channel (PSSCH) or as a standalone reference signal transmission.

42. The apparatus of claim 41, wherein the processing circuitry comprises a processor and a memory coupled with the processor, a radio frequency circuitry coupled with the processor, and one or more antennas coupled with the radio frequency circuitry.

43. The apparatus of claim 41, wherein the set of resources comprises resources within a dedicated resource pool, resources within a shared resource pool, or a combination thereof.

44. The apparatus of claim 41, the processing circuitry to cause transmission of the SL control information comprising a priority field, the source identifier (ID) field, the destination field, a resource reservation period field, the cast-type indicator field, a second stage SCI format field, a time resource assignment field, and a resource identification field.

45. The apparatus of claim 41, the processing circuitry to cause transmission of the SL control information in a first stage SCI format, SCI format 1-B, via a physical sidelink control channel (PSCCH).

46. The apparatus of claim 45, wherein the first stage SCI format, SCI format 1-B, comprises a priority field, the source identifier (ID) field, the destination field, the cast-type indicator field, a resource reservation period field, and a time resource assignment field.

47. The apparatus of claim 41, the processing circuitry to cause transmission of the SL control information in a first stage SCI format, SCI format 1-B, via a physical sidelink control channel (PSCCH) and in a second stage SCI format, SCI format 2-D, via the PSSCH.

48. The apparatus of claim 47, wherein the second stage SCI format, SCI format 2-D, comprises a resource identification field.

49. The apparatus of claim 41, the processing circuitry to further
perform resource selection from a resource pool to determine a set of resources from the resource pool for transmission of a reference signal; and
autonomously determine an allocation of the set of resources for transmission of the reference signal for scheduling the reference signal and the positioning information.

50. The apparatus of claim 41, the processing circuitry to cause transmission of the SL control information via a unicast, broadcast, or groupcast transmission.

51. The apparatus of claim 41, wherein the reference signal comprises a sidelink positioning reference signal (SL PRS), a demodulation reference signal (DMRS), or a channel state information reference signal (CSI-RS).

52. A machine-readable medium containing instructions for user equipment (UE) to allocate sidelink (SL) resources for sidelink communications, which when executed by a processor, cause the processor to perform operations, the operations to:
generate a SL control information to signal a set of resources for a reference signal, the SL control information comprising a source identifier field, a destination identifier field, a cast-type indicator field, and a resource reservation period;
encode the SL control information for transmission to a second UE via the interface; and
cause transmission of the SL control information to allocate the set of resources for the reference signal within a physical sidelink shared channel (PSSCH) or as a standalone reference signal transmission.

53. The machine-readable medium of claim 52, wherein the set of resources comprises resources within a dedicated resource pool, resources within a shared resource pool, or a combination thereof.

54. The machine-readable medium of claim 52, wherein the SL control information comprises a priority field, the source identifier (ID) field, the destination field, a resource reservation period field, the cast-type indicator field, a second stage SCI format field, a time resource assignment field, and a resource identification field.

55. The machine-readable medium of claim 52, wherein the SL control information is encoded within a first stage SCI format, SCI format 1-B; or partially within the first stage SCI format, SCI format 1-B, and partially a second stage SCI format, SCI format 2-D.

56. An apparatus for sidelink (SL) positioning, comprising:
an interface for wireless communication; and
processing circuitry coupled with the interface to:
decode a SL control information (SCI) within a first stage SCI format from a second user equipment (UE) for a reference signal, the SL control information within the first stage SCI format comprising a source identifier field, a destination identifier field, a cast-type indicator field, and a resource reservation period;
decode a SCI within a second stage SCI format from the second UE for the reference signal; and
cause transmission of a response to receipt of the reference signal with positioning information via the interface.

57. The apparatus of claim 56, wherein the first stage SCI format comprises SCI format 1-B and the second stage SCI format comprises SCI format 2-D.

58. The apparatus of claim 57, wherein the second stage SCI format comprises a resource identification field.

59. A machine-readable medium containing instructions for sidelink (SL) positioning, which when executed by a processor, cause the processor to perform operations to:
decode a SL control information (SCI) within a first stage SCI format from a second user equipment (UE) for a reference signal, the SL control information within the first stage SCI format comprising a source identifier field, a destination identifier field, a cast-type indicator field, and a resource reservation period;
decode a SL control information within a second stage SCI format from the second UE for the reference signal; and
cause transmission of a response to receipt of the reference signal with positioning information via the interface.

60. The machine-readable medium of claim 59, wherein the first stage SCI format comprises SCI format 1-B and the second stage SCI format comprises SCI format 2-D, wherein the second stage SCI format comprises a resource identification field.
